(19) United States
(12) Patent Application Publication
(10) Pub. No.: US 2023/0397282 A1
(43) Pub. Date: Dec. 7, 2023

(54) METHODS FOR ADAPTING A RADIO LINK PROCEDURE FOR UE POWER SAVING

(71) Applicant: Telefonaktiebolaget LM Ericsson (publ), Stockholm (SE)

(72) Inventors: Santhan THANGARASA, Vällingby (SE); Muhammad Ali KAZMI, Sundbyberg (SE); Kazuyoshi UESAKA, Kawasaki, Kanagawa (JP)

(21) Appl. No.: 18/032,846

(22) PCT Filed: Oct. 22, 2021
(86) PCT No.: PCT/EP2021/079420

§ 371 Date: Apr. 20, 2023

Related U.S. Application Data
(60) Provisional application No. 63/104,177, filed on Oct. 22, 2020.

(51) Int. Cl. H04W 76/19; H04W 76/20

(52) U.S. Cl. CPC H04W 76/19; H04W 76/20

(57) ABSTRACT

A method performed by a communication device includes obtaining criteria associated with a first mode of operation and a second mode of operation of a Radio Link Procedure (RLP) to be performed by the communication device. The method further includes selecting one of the first mode of operation and the second mode of operation to perform the RLP based on the criteria. The method further includes performing the RLP according to the first mode of operation or the second mode of operation based on the selection.

### TECHNICAL FIELD

The present disclosure relates generally to communications, and more particularly to communication methods and related devices and nodes supporting wireless communications. More specifically, the present disclosure relates methods for adapting radio link procedures to reduce power consumption by a user equipment (UE).

### BACKGROUND

Radio Link Monitoring (RLM) evaluation in New Radio (NR) is performed based on up to 8 RLM reference signal (RLM-RS) resources configured by the network, where:
One RLM-RS resource can be either one SS/PBCH (synchronization signal/physical broadcast channel) block or one channel state information-reference signal (CSI-RS) resource/port,
The RLM-RS resources are UE-specifically configured.
   According to 3rd generation partnership project (3GPP) test specification (TS) 38.133 V16.5.0, Radio link procedure is applicable for
Primary Cell (PCell) in standalone new radio (SA NR), new radio-dual connectivity (NR-DC) and NR-E-UTRA (NR-evolved-UMTS(universal mobile telephone system) terrestrial radio access) dual connectivity (NE-DC) operation mode,
Primary Secondary Cell (PSCell) in NR-DC and EN-DC operation mode.

The SS/PBCH block further comprises channels/signals (e.g., primary synchronization signal (PSS), secondary synchronization signal (SSS), PBCH, demodulation reference signal (DMRS) for PBCH, CSI-RS, etc.) periodically for UE to synchronize with the network and to acquire channel information. Such channels/signals are transmitted at the same transmission burst called discovery reference signals (DRS). DRS is transmitted by the base station periodically with certain periodicity e.g. 20 ms, 40 ms, 80 ms, 160 ms etc. Each synchronization signal block (SSB) or SSB based measurement timing configuration (SMTC) occasion, which occurs periodically contains one or more SSB/PBCH signals. SMTC contains, for example, SS/PBCH blocks or SSB, CSI-RS, PDSCH for transmitting SIBl. The UE is configured with information about SSB on cells of a carrier and called as SMTC, which comprises SMTC periodicity, SMTC occasion length in time or duration, SMTC time offset with respect to reference time (e.g. serving cell's SFN (system frame number)).

The UE is configured with one or more RLM-RS resources for each of which the UE shall estimate the downlink radio link quality (e.g., signal to noise ratio (SNR), signal to interference plus noise ratio (SINR), reference signal received power (RSRP)), and compare it to the thresholds Qout and Qin (derived based on a hypothetical physical downlink control channel block error rate (PDCCH BLER)) for the purpose of monitoring downlink radio link quality of the cell. More specifically, the UE shall be able to evaluate whether the downlink radio link quality on the configured RLM-RS resource estimated over the last OOS evaluation period (TEvaluate_out) becomes worse than the threshold Qout within TEvaluate_out evaluation period, and the UE shall be able to evaluate whether the downlink radio link quality on the configured RLM-RS resource estimated over the last IS evaluation period (TEvaluate_in) becomes better than the threshold Qin within TEvaluate_in evaluation period.

In frequency range #2 (FR2) (mmwave e.g. for frequencies between 24 GHz and 52.6 GHz), the RLM evaluation period additionally applies Rx beam sweeping factor, N, where it is assumed UE tries to receive RLM-RS with different Rx beam configuration to measure the RLM-RS. Example of N is 8. This means OOS and IS evaluation periods in FR2 are N times longer than the corresponding OOS and IS evaluation periods in frequency range #1 (FR1) (e.g. frequencies between 400 MHz and 7 GHz).

Beam management (BM) in NR is a procedure to maintain the beam connection for transmission and reception. The beam management is also interchangeably called as link recovery procedure. The beam management broadly comprises one or more of beam related procedures e.g. beam establishment, beam failure recovery, and beam indication (or beam reporting).

Beam establishment is a procedure where UE selects the best (strongest) beam when it connects to the network. In order to identify the beam, the base station (gNB) transmits different SS/PBCH block and/or CSI-RS per beam. The beam establishment is usually performed at the same time UE performs the initial cell search. At the initial cell search, UE searches for the strongest SS/PBCH block and identifies its location in time domain, because it corresponds to the beam ID. After UE has found the beam, UE tries to connect to the network using this beam. While UE connects to the network, UE measure the downlink link quality of connecting beam. If the link quality level below a threshold, UE triggers the beam failure and start the beam recovery procedure.

Beam failure recovery is a procedure when UE updates the beam in the same cell when the current beam becomes weak due to the channel condition changes, e.g., UE location change or rotation. Beam indication is a procedure where UE reports the beam condition (e.g., received signal power on the beam) to the network as CSI reporting.

According to 3GPP TS38.133 V16.5.0, beam management procedure is applicable for:
PCell in standalone (SA), new radio-dual connectivity (NR-DC), or new radio-evolved-UMTS terrestrial radio access-dual connectivity (NE-DC) operation mode,
PSCell in NR-DC and evolved-universal terrestrial radio access new radio-dual connectivity (EN-DC) operation mode, or
SCell in carrier aggregation.

Beam recovery procedure is a procedure to recover beam connection when the beam UE is monitoring becomes weak. UE measures the channel quality of the periodic SS/PBCH block and/or CSI-RS resources (q0) in a serving cell. If the measured quality is below the threshold Qout_LR, corresponding to hypothetical PDCCH BLER of 10%, UE physical layer indicates beam failure to the medium access control (MAC) layer. This event is called beam failure detection (BFD).

In FR2, the BFD evaluation period additionally applies Rx beam sweeping factor, N, where it is assumed UE tries to receive RLM-RS with different Rx beam configuration to measure the BFD-RS. Example of N is 8. This means BFD evaluation period in FR2 is N times longer than the BFD evaluation period in FR1.

After BFD, UE searches for candidate beams from the configured CSI-RS and/or SS/PBCH block resources for candidate beam detection (q1) in the serving cell. UE determines one of the beams in q1 whose L1-RSRP exceeds the threshold rsrp-Threshold which is signaled from the network. This procedure is called candidate beam detection (CBD).

After determining the new beam in PCell/PSCell, UE reports the selected beam with the random access procedure, where UE transmits random access preamble on the physical random access control channel (PRACH) corresponding to the SS/PBCH block and/or CSI-RS resource. After determining the new beam in SCell, UE reports the selected beam with the Beam failure recovery (BFR) message in a medium access control, MAC, control element MAC CE.

In FR2, the CBD evaluation period additionally applies receiver (Rx) beam sweeping factor, N, where it is assumed UE tries to receive CBD-RS with different Rx beam configuration to measure the CBD-RS. Example of N is 8. N is the scaling factor depending on the configured cells as same ad CBD evaluation in FR1. This means CBD evaluation period in FR2 is N times longer than the CBD evaluation period in FR1.

L1-RSRP reporting in NR is a part of the CSI reporting procedure and UE reports the received power of the configured number of beams. The network uses the information to determine which beam is to be used to transmit data (PDCCH/PDSCH). L1-RSRP reporting is configured as periodic, aperiodic, or semi-persistent. For the periodic reporting, UE shall transmit L1-RSRP on physical uplink control channel (PUCCH) according to the periodicity configured by the network. For the aperiodic L1-RSRP reporting, UE shall transmit L1-RSRP on PUSCH after the UE receives CSI request in downlink control information (DCI). For the semi-persistent L1-RSRP reporting, UE shall transmit L1-RSRP reporting on PUSCH or PUCCH according to the periodicity specified by the higher layer. For the semi-persistent reporting the UE stops L1-RSRP reporting after the configured number of report transmissions. The reporting period is given by T_{Report}.

In FR2, the L1-RSRP measurement period additionally applies Rx beam sweeping factor, N, where it is assumed UE tries to receive SSB with different Rx beam configuration to measure the SSB. Example of N is 8. This means L1-RSRP measurement period in FR2 is N times longer than the L1-RSRP measurement in FR1.

Similar to L1-RSRP reporting, L1-SINR reporting is also a part of the CSI reporting procedure and UE reports the ratio of received power of the channel measurement resources (CMR) and received power of the interference measurement resource (IMR). 3GPP assumes CMR is SSB or CSI-RS, and IMR is Non-zero-power CSI-RS (NZP-CSI-RS) or zero-power CSI-RS (ZP-CSI-RS).

In FR2, the L1-SINR measurement period additionally applies Rx beam sweeping factor, N, where it is assumed UE tries to receive SSB and IMR with different Rx beam configuration to measure the SSB and IMR. Example of N is 8. This means L1-SINR measurement period in FR2 is N times longer than the L1-SINR measurement in FR1. Both L1-RSRP and L1-SINR reporting are part of beam indication or beam reporting.

Two of the fundamental procedures in RRC CONNECTED state to ensure that UE maintains reliable communication with the serving cell(s) are radio link monitoring (RLM) and beam management (BM) as discussed above. Both RLM and BM procedures requires the UE to perform certain steps or activities periodically or at least with certain periodicity e.g. every radio frame, every discontinuous reception (DRX) cycle, every BM/RLM-RS transmission periodicity. Examples of such activities are performing measurement, processing the measurement (e.g. comparing to thresholds), triggering events/indications, triggering new procedures based on the outcome of the evaluations, etc. Such frequent measurement and/or processing activities can significantly increase the UE power consumption. In low mobility or stationary scenario, the UE is expected to have limited or no mobility. In such scenarios the radio conditions experienced by the UE may not change very much over the time. Therefore, performing the measurements for RLM and/or BM procedures with short periodicity all the time in all scenarios will increase UE power consumption and UE processing. Thus, there is a need to enable the UE to perform the RLM and/or BM procedures while decreasing UE power consumption and UE processing.

### SUMMARY

According to some embodiments of inventive concepts, a method, performed by a communication device, includes obtaining criteria associated with a first mode of operation and a second mode of operation of a Radio Link Procedure (RLP) to be performed by the communication device. The method includes selecting one of the first mode of operation and the second mode of operation to perform the RLP based on the criteria. The method further includes performing the RLP according to the first mode of operation or the second mode of operation based on the selection.

Communication devices and computer programs having analogous operations are also provided.

Advantages that may be achieved include a network radio better utilized as the network (NW) can use reported information for adapting its transmission. For example, when the NW knows that the UE has entered into a relaxation state, then the NW can avoid transmitting signals/channels in occasions where the UE is not likely to receive those. Another advantage includes improved UE power consumption, i.e. UE can enter a relaxed mode and sleep over longer time especially when it has limited mobility and/or when it is not expected to be scheduled frequently. In another example, operation of RLPs in relaxed mode is allowed only in scenarios where there is no or very little performance degradation.

According to other embodiments of inventive concepts, a method, performed by a communication device, includes obtaining criteria associated with a first Radio Link Procedure (RLP) and a second RLP to be performed by the communication device. The method includes determining whether to perform the first RLP and the second RLP according to a first mode of operation or a second mode of operation based on the criteria. The method further includes performing the first RLP and the second RLP according to the first mode of operation or the second mode of operation based on the determination.

Communication devices and computer programs having analogous operations are also provided.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a block diagram illustrating a communication device UE according to some embodiments of the present disclosure;

FIG. 2 is a block diagram illustrating a radio access network RAN node (e.g., a base station eNB/gNB) according to some embodiments of the present disclosure;

FIG. 3 is a block diagram illustrating a core network CN node (e.g., an AMF node, an SMF node, etc.) according to some embodiments of the present disclosure;

FIG. 4 is a diagram illustrating an example timeline of a UE starting a radio link failure timer after detecting out of sync indications according to some embodiments of the present disclosure;

FIG. 5 is a diagram illustrating an example of a UE switching between a current operational mode and a new operational mode according to some embodiments of the present disclosure;

FIG. 6 is a flow chart illustrating operations of a communication device to perform an RLP according to a first or second mode of operation according to some embodiments of the present disclosure;

FIG. 7 is a flow chart illustrating operations of the communication device to select a first mode of operation to perform the RLP according to some embodiments of the present disclosure;

FIG. 8 is a flow chart illustrating operations of the communication device to select a second mode of operation to perform the RLP according to some embodiments of the present disclosure;

FIG. 9 is a flow chart illustrating operations of the communication device to perform a first RLP and a second RLP according to a first mode of operation or second mode of operation according to some embodiments of the present disclosure;

FIG. 10 is a flow chart illustrating operations of the communication device determining whether to perform a first RLP and a second RLP according to a first mode of operation or a second mode of operation based on criteria and information according to some embodiments of the present disclosure;

FIG. 11 is a flow chart illustrating operations of the communication device determining to perform a second RLP according to a second mode of operation according to some embodiments of the present disclosure;

FIG. 12 is a flow chart illustrating operations of the communication device determining to perform a second RLP according to a first mode of operation according to some embodiments of the present disclosure;

FIG. 13 is a block diagram of a wireless network in accordance with some embodiments;

FIG. 14 is a block diagram of a user equipment in accordance with some embodiments

FIG. 15 is a block diagram of a virtualization environment in accordance with some embodiments;

FIG. 16 is a block diagram of a telecommunication network connected via an intermediate network to a host computer in accordance with some embodiments;

FIG. 17 is a block diagram of a host computer communicating via a base station with a user equipment over a partially wireless connection in accordance with some embodiments;

FIG. 18 is a block diagram of methods implemented in a communication system including a host computer, a base station and a user equipment in accordance with some embodiments;

FIG. 19 is a block diagram of methods implemented in a communication system including a host computer, a base station and a user equipment in accordance with some embodiments;

FIG. 20 is a block diagram of methods implemented in a communication system including a host computer, a base station and a user equipment in accordance with some embodiments; and

FIG. 21 is a block diagram of methods implemented in a communication system including a host computer, a base station and a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

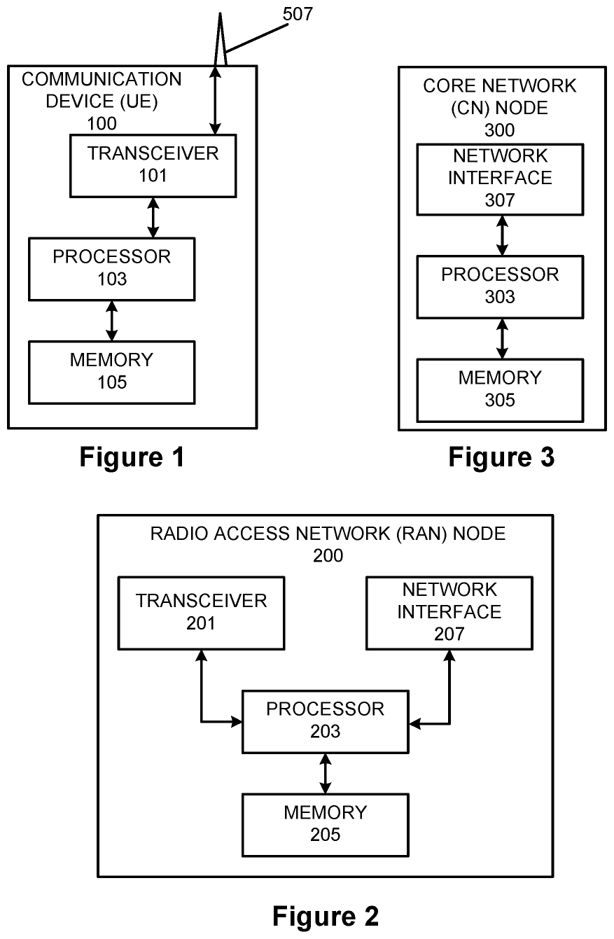

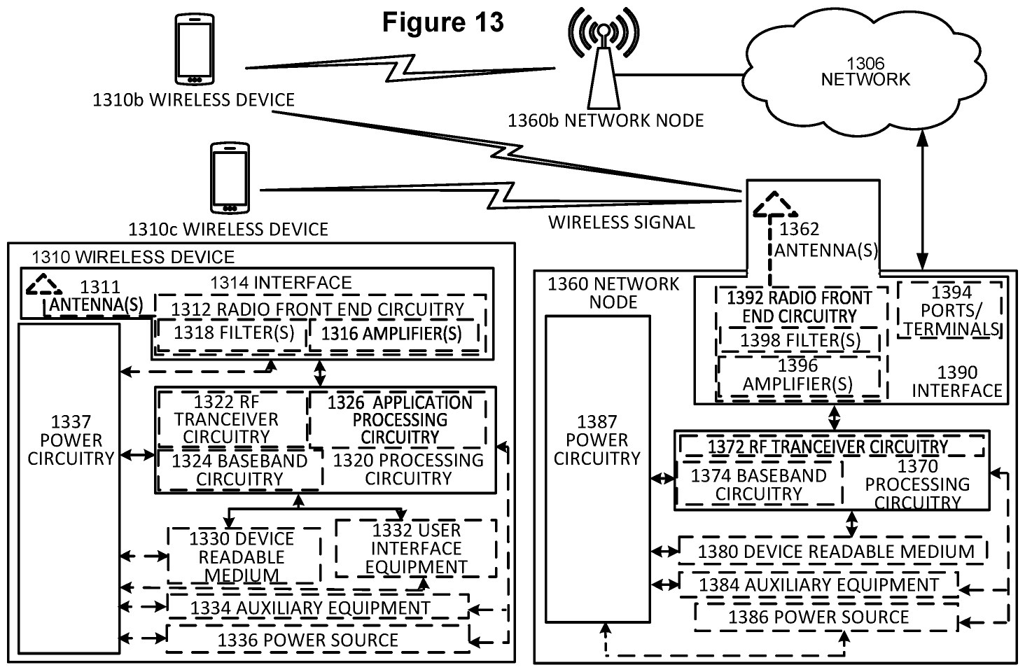

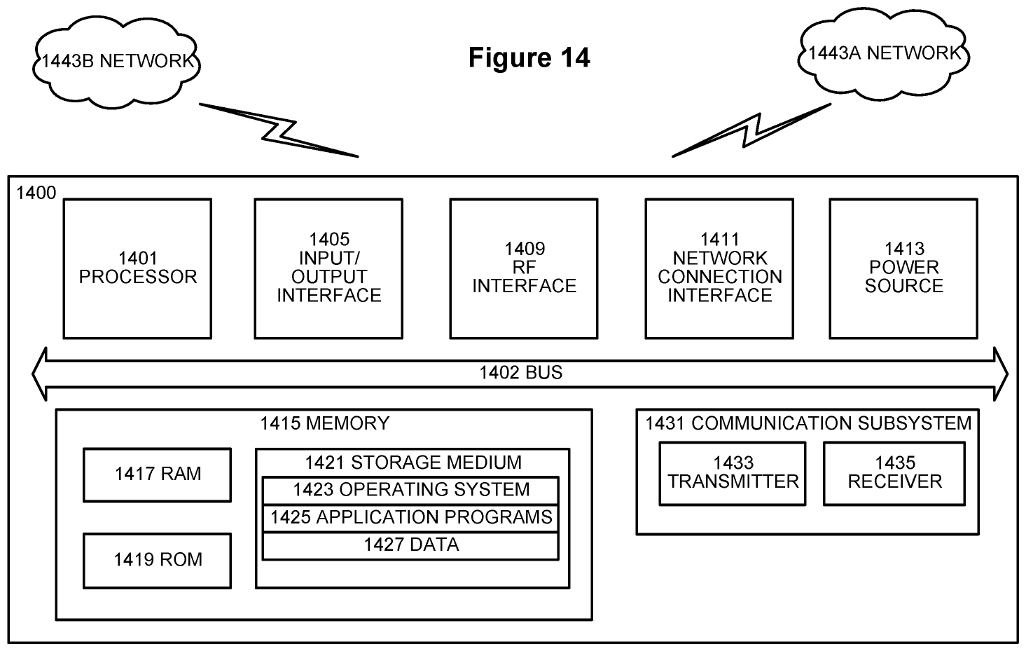

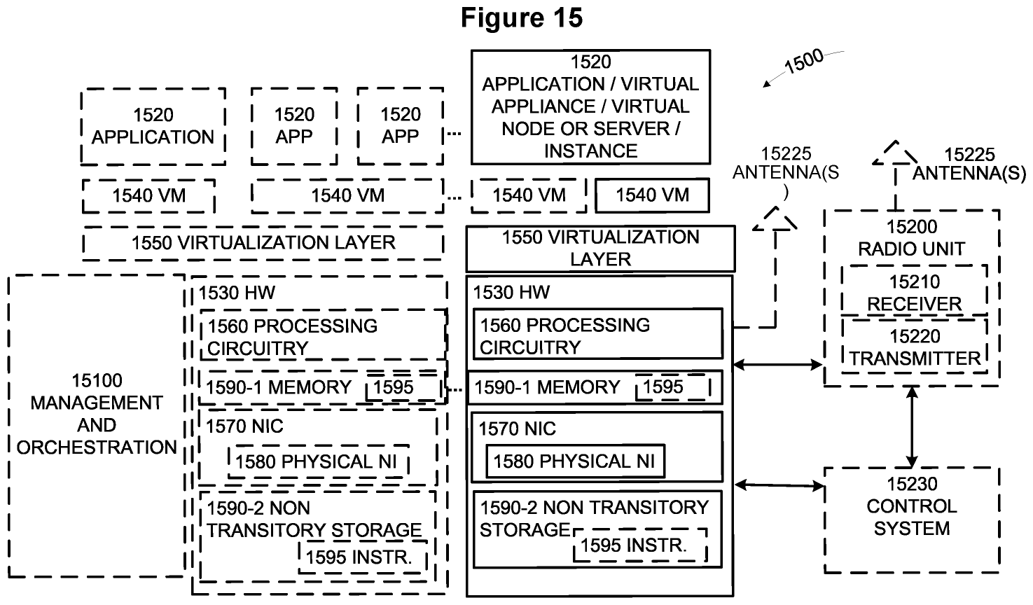

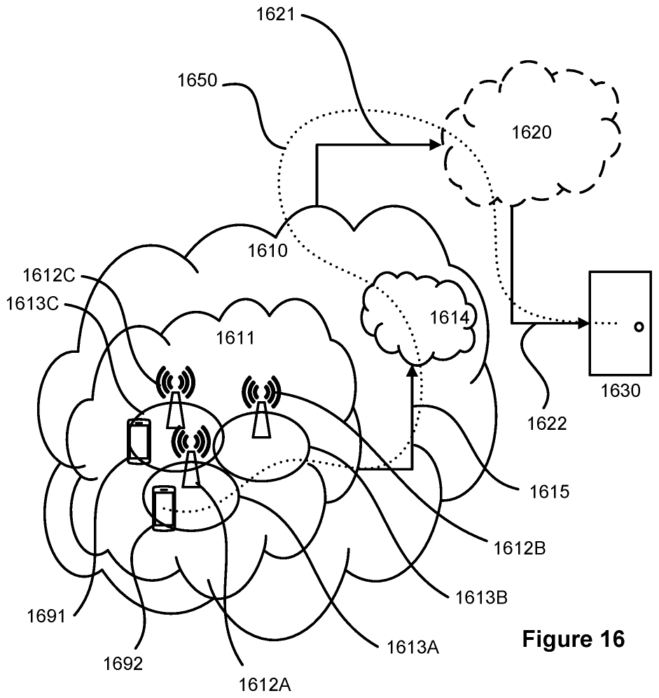

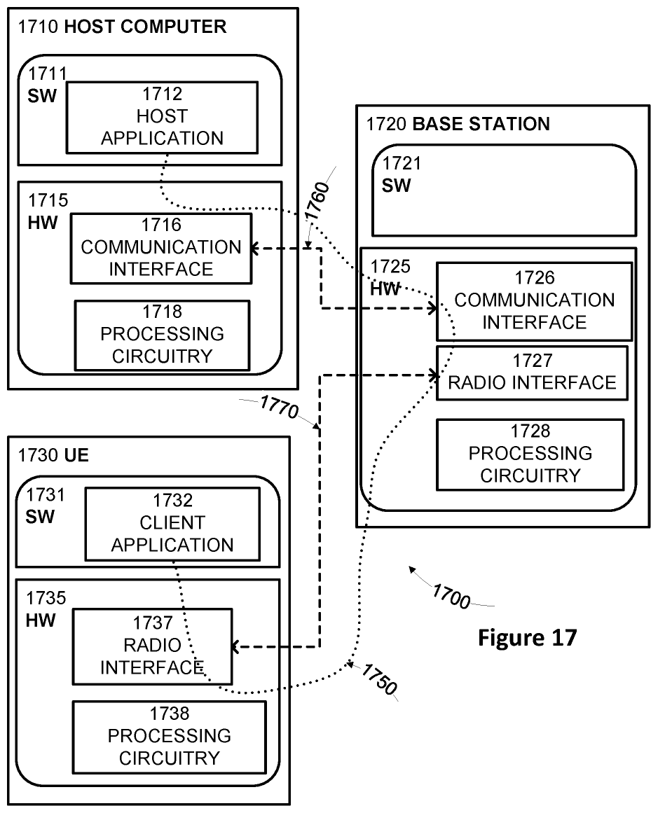

FIG. 1 is a block diagram illustrating elements of a communication device UE 100 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 100 may be provided, for example, as discussed below with respect to wireless device 1310 of FIG. 13, UE 1400 of FIG. 14, hardware 1530 and virtual machine 1540 of FIG. 15, UEs 1691, 1692 of FIG. 16, and UE 1730 of FIG. 17.) As shown, communication device UE may include an antenna 107 (e.g., corresponding to antenna 1311 of FIG. 13), and transceiver circuitry 101 (also referred to as a transceiver, e.g., corresponding to interface 1314 of FIG. 13) including a transmitter and a receiver configured to provide uplink and downlink radio communications with a base station(s) (e.g., corresponding to network node 1360 of FIG. 13, also referred to as a RAN node) of a radio access network. Communication device UE may also include processing circuitry 103 (also referred to as a processor, e.g., corresponding to processing circuitry 1320 of FIG. 13, processor 1401 of FIG. 14, processing circuitry 1560 of FIG. 15, and/or processing circuitry 1738 of FIG. 17) coupled to the transceiver circuitry, and memory circuitry 105 (also referred to as memory, e.g., corresponding to device readable medium 1330 of FIG. 13, memory 1415 of FIG. 14, and memory 1590-1 and 1590-2 of FIG. 15) coupled to the processing circuitry. The memory circuitry 105 may include computer readable program code that when executed by the processing circuitry 103 causes the processing circuitry to perform operations according to embodiments disclosed herein. According to other embodiments, processing circuitry 103 may be defined to include memory so that separate memory circuitry is not required. Communication device UE may also include an interface (such as a user interface) coupled with processing circuitry 103, and/or communication device UE may be incorporated in a vehicle.

As discussed herein, operations of communication device UE may be performed by processing circuitry 103 and/or transceiver circuitry 101. For example, processing circuitry 103 may control transceiver circuitry 101 to transmit communications through transceiver circuitry 101 over a radio interface to a radio access network node (also referred to as a base station) and/or to receive communications through transceiver circuitry 101 from a RAN node over a radio interface. Moreover, modules may be stored in memory circuitry 105, and these modules may provide instructions so that when instructions of a module are executed by processing circuitry 103, processing circuitry 103 performs respective operations (e.g., operations discussed below with respect to Example Embodiments relating to wireless communication devices).

FIG. 2 is a block diagram illustrating elements of a radio access network RAN node 200 (also referred to as a network node, base station, eNodeB/eNB, gNodeB/gNB, etc.) of a Radio Access Network (RAN) configured to provide cellular communication according to embodiments of inventive concepts. (RAN node 200 may be provided, for example, as discussed below with respect to network node 1360 of FIG. 13, hardware 1530 or virtual machine 1540 of FIG. 15, and/or base station 1720 of FIG. 17.) As shown, the RAN node may include transceiver circuitry 201 (also referred to as a transceiver, e.g., corresponding to portions of interface 1390 of FIG. 13) including a transmitter and a receiver configured to provide uplink and downlink radio communications with mobile terminals. The RAN node may include network interface circuitry 207 (also referred to as a network interface, e.g., corresponding to portions of interface 1390 of FIG. 13 and communication interface 1726 or radio interface 1727 of FIG. 17) configured to provide communications with other nodes (e.g., with other base stations) of the RAN and/or core network CN. The network node may also include processing circuitry 203 (also referred to as a processor, e.g., corresponding to processing circuitry 1370) coupled to the transceiver circuitry, and memory circuitry 205 (also referred to as memory, e.g., corresponding to device readable medium 1380 of FIG. 13) coupled to the processing circuitry. The memory circuitry 205 may include computer readable program code that when executed by the processing circuitry 203 causes the processing circuitry to perform operations according to embodiments disclosed herein. According to other embodiments, processing circuitry 203 may be defined to include memory so that a separate memory circuitry is not required.

As discussed herein, operations of the RAN node may be performed by processing circuitry 203, network interface 207, and/or transceiver 201. For example, processing circuitry 203 may control transceiver 201 to transmit downlink communications through transceiver 401 over a radio interface to one or more mobile terminals UEs and/or to receive uplink communications through transceiver 201 from one or more mobile terminals UEs over a radio interface. Similarly, processing circuitry 203 may control network interface 207 to transmit communications through network interface 207 to one or more other network nodes and/or to receive communications through network interface from one or more other network nodes. Moreover, modules may be stored in memory 205, and these modules may provide instructions so that when instructions of a module are executed by processing circuitry 203, processing circuitry 203 performs respective operations (e.g., operations discussed below with respect to Example Embodiments relating to RAN nodes).

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 3 is a block diagram illustrating elements of a core network CN node 300 (e.g., an SMF node, an AMF node, etc.) of a communication network configured to provide cellular communication according to embodiments of inventive concepts. As shown, the CN node may include network interface circuitry 307 (also referred to as a network interface) configured to provide communications with other nodes of the core network and/or the radio access network RAN. The CN node may also include a processing circuitry 303 (also referred to as a processor) coupled to the network interface circuitry, and memory circuitry 305 (also referred to as memory) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that a separate memory circuitry is not required.

As discussed herein, operations of the CN node may be performed by processing circuitry 303 and/or network interface circuitry 307. For example, processing circuitry 303 may control network interface circuitry 307 to transmit communications through network interface circuitry 307 to one or more other network nodes and/or to receive communications through network interface circuitry from one or more other network nodes. Moreover, modules may be stored in memory 305, and these modules may provide instructions so that when instructions of a module are executed by processing circuitry 303, processing circuitry 303 performs respective operations (e.g., operations discussed below with respect to Example Embodiments relating to core network nodes).

According to a first embodiment the UE obtains information about first set (S1) of criteria and a second set (S2) of criteria, for determining whether the UE can operate one or more radio link procedures (RLPs) (e.g. RLM based on SSB, RLM based on CSI-RS, BM based on SSB, BM based on CSI-RS, RLM based on any RS, BM based on any RS, etc) in certain operational mode e.g. relaxed mode or in normal mode. For example, the UE evaluates the criteria and based on the evaluation performs RLP in relaxed mode provided that at least one criterion in set S1 and at least one criterion in set S2 are met. Otherwise the UE performs RLP in normal mode if RLP was being performed in relaxed mode before the evaluation or continue performing the RLP in normal mode if RLP was being already performed in normal mode before the evaluation.

According to a second embodiment the scenario comprising a UE configured to perform at least two RLPs on the same cell (e.g. on PCell) and meets the criteria for at least one of the RLPs (e.g. RLP1 such as RLM) to perform that RLP (e.g. RLP1 such as RLM) in relaxed mode but does not meet the criteria for at least one of the RLPs (e.g. RLP2 such as BM) to perform that RLP (e.g. RLP2 such as BM) in relaxed mode. According to the embodiment, whether the UE can also perform the RLPs (e.g. RLP2), which do not meet the relaxation criteria, in relaxed mode is governed by one or more rules. The rules can be pre-defined or configured by the network node.

The evaluation of the criteria (in S1 and/or in S2) may comprise UE performing measurements on the signals operating between the UE and a cell (e.g. serving cell) and comparing it to one or more thresholds. As a result of the evaluation, the UE may remain in the current operational mode (e.g. first operational mode (OM1)), or it may switch to a new operational mode (e.g. a second operational mode (OM2)) different than the current operational mode (e.g. OM1), where:
OM1 and OM2 are associated with a first set of requirements (R1) and a second set of requirements (R2). At least one of the requirements in R1 and R2 are different.
   In one example at least one requirement (e.g. measurement time) in R1 is more stringent than the corresponding requirement (e.g. measurement time) in R2.
   In another example at least one requirement (e.g. measurement time) in R1 is less stringent (more relaxed) than the corresponding requirement (e.g. measurement time) in R2.

The criteria in S1 are related to conditions or scenarios under which the UE can perform RLPs in relaxed mode. Examples of criteria in set S1 comprising one or combination of the following:
UE speed e.g. This can be expressed in different speed levels (e.g. low, medium, high etc). For example, low mobility criterion is met at low UE speed.
UE location in the cell e.g. whether UE is in cell edge or the UE is not-at-cell-edge.

The criteria in S2 are related to conditions which impact the performance of RLPs in relaxed mode. Examples of criteria in set S2 comprising one or combination of the following:
Beam failure detection e.g. whether UE has detected beam failure in the last D1 period
in sync (IS) detection e.g. whether UE has detected certain number of IS in the last D2 period
out of sync (OOS) detection e.g. whether UE has detected certain number of OOS in the last D3 period
Candidate beam detection e.g. whether UE has detected candidate beam in the last D4 period
Radio link failure trigger e.g. whether the RLF timer is running.

Examples of the operational modes are:
Normal operational mode
Relaxed RLM mode
Relaxed BM mode
Relaxed RLM and relaxed BM mode

Each exemplary operational mode is associated with at least one set of requirements. Examples of requirements are IS evaluation period in RLM, OOS evaluation period in RLM etc. The UE obtains information related to one or more criteria using one or more following ways:
The UE is configured by a network node with one or more relaxation criteria for one or more RLPs (e.g. RLM, BM) e.g. via higher layer signalling such as RRC
The UE is pre-configured with one or more relaxation criteria, e.g. preconfigured on SIM (subscriber identity module)
The one or more relaxation criteria is predefined, e.g. predefined in the standard
UE autonomously enters the relaxation based on a certain trigger, e.g. triggering condition is predefined, configured by the network node or autonomously determined by the UE.

There are multiple advantages to the solutions described herein. For example, network radio better utilized as the network (NW) can use the reported information for adapting its transmission. For example, when NW knows that the UE has entered into a relaxation state, then the NW can avoid transmitting signals/channels in occasions where the UE is not likely to receive those. Another advantage includes improved UE power consumption, i.e. UE can enter a relaxed mode and sleep over longer time especially when it has limited mobility and/or when it is not expected to be scheduled frequently. In another example, operation of RLPs in relaxed mode is allowed only in scenarios where there is no or very little performance degradation.

In some embodiments a more general term “network node” is used and it can correspond to any type of radio network node or any network node, which communicates with a UE and/or with another network node. Examples of network nodes are radio network node, gNodeB (gNB), ng-eNB, base station (BS), NR base station, TRP (transmission reception point), multi-standard radio (MSR) radio node such as MSR BS, network controller, radio network controller (RNC), base station controller (BSC), relay, access point (AP), transmission points, transmission nodes, remote radio unit (RRU), remote radio head (RRH), nodes in distributed antenna system (DAS), core network node (e.g. mobile switching center (MSC), mobility management entity (MME), etc), operations and management (O&M), operations support system (OSS), self-organizing network (SON), positioning node or location server (e.g. evolved-serving mobile location centre E-SMLC), minimization of drive tests (MDT), test equipment (physical node or software), etc.

In some embodiments the non-limiting term user equipment (UE) or wireless device is used, and it refers to any type of wireless device communicating with a network node and/or with another UE in a cellular or mobile communication system. Examples of UE are wireless device supporting NR, target device, device to device (D2D) UE, machine type UE or UE capable of machine to machine (M2M) communication, personal digital assistant (PDA), personal access device (PAD), Tablet, mobile terminals, smart phone, laptop embedded equipped (LEE), laptop mounted equipment (LME), drone, universal serial bus (USB) dongles, proximity services (ProSe) UE, vehicle-to-vehicle (V2V) UE, vehicle to anything (V2X) UE, etc.

The term “radio node” may refer to radio network node or UE capable of transmitting radio signals or receiving radio signals or both. The term radio access technology, or RAT, may refer to any RAT e.g. universal terrestrial radio access (UTRA), evolved-UTRA (E-UTRA), narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The UE performs measurements on reference signal (RS). Examples of RS are discovery signal or discovery reference signal (DRS), synchronization and signal block (SSB), CSI-RS, cell specific reference signal (CRS), demodulation reference signal (DMRS), primary synchronization signal (PSS), secondary synchronization signal (SSS) etc. Examples of measurements are cell identification (e.g. PCI acquisition, cell detection), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, acquisition of system information (SI), cell global ID (CGI) acquisition, Reference Signal Time Difference (RSTD), UE RX-TX time difference measurement, radio link quality, Radio Link Monitoring (RLM), which consists of Out of Synchronization (out of sync) detection and In Synchronization (in-sync) detection, Layer-1 RSRP (L1-RSRP), Layer-1 SINR (L1-SINR) etc.

The term radio link procedure (RLP) used herein may refer to any procedure performed by the UE on radio signals operating between UE and a cell e.g. between UE and special cell (SpCell), between UE and secondary cell (SCell) etc. In one example RLPs may differ based on their functionality or purpose. In another example RLPs may differ based on the type of reference signal used by the RLP e.g. SSB, CSI-RS etc. Examples of RLP performing different functions are RLM, BM, one or more procedures related to RLM (e.g. out of sync and/or in-sync evaluation, radio link failure detection), one or more procedures related to BM (e.g. BFD, CBD, L1-RSRP reporting, L1-SINR reporting etc), etc. Another set of examples of RLPs using different RS are RLM based on SSB, RLM based on CSI-RS, RLM based on both SSB and CSI-RS etc. Another set of examples of RLPs using different RS are BM on based on SSB, BM based on CSI-RS etc.

The term relaxed mode or relaxed operational mode used herein refer to performing certain RLP, which is associated with one or more relaxed requirements compared to those associated with the normal mode of operation of the RLP. The normal mode (NM) is interchangeably called as legacy mode, mode without any relaxation etc. The corresponding requirements associated with NM are also called as reference requirements, legacy requirements, normal requirements etc. Examples of requirements are measurement time, measurement accuracy, measurement reporting periodicity, measurement etc. Examples of measurement time are evaluation period or measurement period e.g. L1 measurement period, L1-RSRP measurement period, L1-SINR measurement period, OOS evaluation period, IS evaluation period, BFD evaluation period, BFD evaluation period, L1 indication interval, IS indication interval, OOS indication interval, BFD indication interval etc. Examples of measurement accuracy are L1-RSRP accuracy (e.g. within ±X1 dB wrt reference L1-RSRP value), L1-SINR accuracy (e.g. within ±X2 dB wrt reference L1-SINR value).

The scenario comprises at least one UE (UE1) which is operating in a first cell (cell1) served by a network node (NW1). The UE may also be served by cell1. The UE may further be served by one or more additional cells (e.g. a second cell (cell2), a third cell (cell3) etc) in multicarrier scenarios such as in carrier aggregation, multi-connectivity, dual connectivity etc. The UE is performing one or more radio link procedures in one or more cells (e.g. cell1, cell2, cell3 etc) based on one or more reference signals (RS) transmitted by NW1. Examples of operating cells (cell1) are SCells, SpCells etc. Examples of SpCell are PCell and PSCell. Examples of radio link procedures carried out by the UE are RLM and BM which are described herein. Examples of RS used by the UE for performing the RLPs are SSBs, CSI-RS, a mix of SSBs, and other examples of RSs are also described, for example, herein above. The present disclosure describes methods performed by the UE for obtaining and applying criteria for performing RLP in a relaxed mode according to some embodiments. The steps involved in the UE, for example, includes:
Step 1: UE obtaining information related to one or more criteria for relaxing one or more RLPs
Step 2: UE evaluating the obtained criteria for its operating cell for determining which operational mode UE shall operate one or more RLPs in
Step 3: UE using the result of the evaluation for operating tasks

In Step 1, the UE obtains information related to two or more criteria for determining whether the UE can perform one or more radio link procedures in the first operational mode (OM1) or in the second operational mode (OM2) e.g. in a relaxed mode if currently operating in a normal mode (NM) or in a normal mode if currently operating in the relaxed mode. The step of obtaining this information can be performed by the UE anytime e.g.
when receiving certain configuration message from the NW node e.g. measurement configuration, RLM and/or BM configuration etc.
when entering a cell for the first time e.g. at initial setup or after cell change,
when performing cell change,
when switching between RRC states (e.g. from RRC IDLE to RRC CONNECTED, from RRC IDLE to RRC INACTIVE, RRC INACTIVE to RRC CONNECTED)
upon explicit request from the network node or
based on internal trigger in the UE.

The UE may obtain the information related to the two or more criteria by one or more mechanisms, which include at least one of following:
by receiving it from the network node for one or more RLPs, e.g. via higher layer signaling such as RRC
pre-configured by the network or operator, e.g. preconfigured in the SIM card or eSIM
predefined in the standard (e.g. technical specification)
UE autonomously determining the criteria based on one or more other triggering condition in the UE, e.g. when the signal level exceeds or goes below a certain level, when a certain event has occurred, or when a certain procedure is triggered.
Historical data or statistics, e.g. criteria used earlier for operating RLPs in a certain mode

The information obtained in this step indicates whether the UE is allowed to enter in a relaxed mode for operating one or more RLPs. Typically, such relaxed mode operation is allowed for UEs operating in low mobility scenarios (e.g. stationary UEs, UE speed below a certain threshold, Doppler frequency below a certain threshold) etc. The obtained information comprising the criteria can be of two types. More specifically the criteria are characterized into two groups:
A first set of criteria (S1) comprising at least one criterion and
A second set of criteria (S2) comprising at least one criterion.

The UE enters into a relaxed mode for operating one or more RLPs provided that at least one criterion in set S1 and at least one criterion in set S2 are met. This mechanism ensures that the performance of the RLP is not degraded when the UE operates in the relaxed mode.

In Step 2, the UE evaluates the criteria (e.g. set S1) obtained in previous step for determining whether to operate RLPs in the relaxed mode or in the normal mode. The purpose of the first set of criteria is to determine whether the UE is operating in a state or conditions or environment in which the UE can be allowed to perform RLPs in a relaxed mode. Examples of such criteria comprising: UE speed, UE location in a cell, UE speed and UE location in a cell, variation in radio conditions, cell changes etc. They are explained below:
UE speed: The UE performs RLPs in relaxed mode in a cell if the UE meets low mobility criterion in that cell; otherwise the UE is not allowed to perform the RLPs in relaxed mode in that cell. In one example low mobility criterion is met when received signal level (e.g. RSRP) at the UE wrt (with respect to) the cell is static or quasi-static over certain time period (Ts). The received signal wrt the cell is static or quasi-static if it does not change by more than certain margin over certain time period.
UE location in a cell. The UE performs RLPs in relaxed mode in a cell if the UE meets not-at-cell edge criterion in that cell; otherwise the UE is not allowed to perform the RLPs in relaxed mode in that cell. For example, the UE meets not-at-cell edge criterion provided that the signal measurement value wrt the cell is above certain threshold; otherwise the UE does not meet the not-at-cell edge criterion.
UE speed and UE location in a cell. The UE performs RLPs in relaxed mode in a cell if the UE meets both low mobility criterion and not-at-cell edge criterion in that cell; otherwise the UE is not allowed to perform RLPs in relaxed mode in that cell.
Variation in radio condition: The UE performs RLPs in relaxed mode in a cell if the variation in the radio conditions for the UE in that cell do not change by more than certain margin over certain time; otherwise the UE is not allowed to perform RLPs in relaxed mode in that cell. The variation in the radio conditions can be determined by estimating the variation of the signal (e.g. measurement such as RSRP) between the UE and that cell.
Cell changes: The UE performs RLPs in relaxed mode in a cell if the UE has not performed more than N1 cell changes over last T1 duration, where N1 and T1 can be configurable or predefined. Examples of cell change are cell reselection, handover, RRC connection release with redirection, RRC connection re-establishment, SCell change in multi-carrier operation, SpCell change etc.

The above criteria can be evaluated by the UE autonomously or by the network node. In the latter case the UE can be informed whether the UE meets one or more criteria for applying RLPs in relaxed mode or not. This is described below:
UE based method: In this case the UE determines whether it meets one or more criteria for operating one or more radio link procedures (RLPs) in the relaxed mode or in the normal mode in a cell. The criteria can be pre-defined or they can be configured by the network node. In one example the UE autonomously evaluates one or more criteria (e.g. periodically or any time) and operate one or more RLPs in the relaxed mode if it meets the criteria for the relaxed mode. In another example the UE is only allowed to operate one or more RLPs in the relaxed mode only if allowed by the network node e.g. upon receiving an explicit message from the network node. The latter approach allows the network node to control the UE operation for entering in the relaxed mode. In this case the UE typically evaluates one or more criteria for entering in relaxed mode only when the UE is configured by the network node to operate in the relaxed mode (if the UE meets the criteria for the relaxed mode).
Network based method: In this case the network node determines whether the UE meets one or more criteria for operating one or more RLPs in the relaxed mode or in the normal mode in a cell. The determination is based on the evaluation of the criteria. Based on the evaluation if network node determines that the UE meets criteria for operating one or more RLPs in the relaxed mode, then the network node sends a message to the UE allowing the UE to operate the RLPs in the relaxed mode. In this case the UE upon receiving the message operates the RLPs in the relaxed mode. On the other hand, if the network node determines that the UE does not meet criteria for operating one or more RLPs in the relaxed mode, then the network node sends a message to the UE forbidding the UE to operate the RLPs in the relaxed mode. In this case the UE upon receiving the message stops or discontinues operating one or more RLPs in the relaxed mode operates. The UE may further start operating RLPs in the normal mode.

The purpose of the second set of criteria (e.g., set S2) is to determine whether the UE operation in relaxed mode will impact the performance of the RLP or not. For example the UE is allowed to perform one or more RLPs in relaxed mode provided that the UE meets at least one criterion in set S2 (in addition to one in set S1) that would ensure that the performance of RLP is not degraded beyond an acceptable level e.g. UE does not lose the radio link, UE is able to detect beam failure etc. The criteria further depend on the type of RLP (e.g. RLM or BM) being performed. The criteria further depend on whether the UE is configured with two or more RLPs (e.g. RLM, BM etc) to be performed on the same cell. For example, the UE may be configured to operate only BM on SCell, only RLM on SpCell (e.g. in FR1) or both RLM and BM on SpCell etc. Examples of these criteria belonging to set S2 for determining whether the UE is allowed to perform one or more RLPs in relaxed mode are described below. At least one of the following criteria (in S2) needs to be met for allowing the UE to operate certain RLPs (e.g. RLM, BM etc.) in relaxed mode (provided at least one criterion in set S1 is also met):
1. In-sync indications: As part of the RLM procedure as described in 2.1.1, the UE is required to evaluate the radio link quality to a threshold called Qᵢₙ (pre-defined in standard e.g. TS 38.133) for determining whether the radio link quality can be received with significantly higher reliability than Qₒᵤₜ threshold, where Qᵢₙ threshold corresponds to a significantly lower hypothetical control channel (PDCCH) BLER target than corresponding Qₒᵤₜ BLER target. In typical operation, BLER target for Qᵢₙ is 2% and Qₒᵤₜ is 10%. The evaluation is done by UE monitoring up to a certain number of configured RLM resources (RLM-RS) and measuring on them. Typical number of RLM resources that UE is configured with can be 2, 4, 8 and is configured by the network node. According to legacy UE behavior, the layer 1 of the UE shall send an in-sync indication for the cell to the higher layers when the downlink radio link quality on at least one of the configured RLM-RS is better than Qᵢₙ. Since in-sync is an indication that the radio link quality is reliable, if several of those are triggered then it can be interpreted as that the radio link quality is very reliable and stable and therefore RLM can be performed in a relaxed mode. Consecutive or large number of in-sync indications may also indicate or imply that the UE mobility is limited or at least the variation in the radio conditions of the UE is limited. Thus, operating the RLP (e.g. RLM, BM etc) in a relaxed mode should have limited performance impact. Therefore, the criteria for entering a relaxed RLP (e.g. RLM) mode comprises:
   If more than K1 in-sync indications have been sent to the higher layers, and/or
      In one example, the number of in-sync indication is compared to a predefined/preconfigured or configurable threshold (K1′) and the UE is allowed to enter the relaxed RLM mode only if: K1≥K1′.
   If more than K2 number of in-sync indications have been sent to the higher layers during T1. In one specific example, T1 is the RLM in-sync evaluation period T_{Evaluate_in}.
      In one example, the UE is allowed to enter the relaxed RLM mode only if: K2≥K1′ during T_{Evaluate_in}.
2. Out-of-sync indications: Similar to the in-sync indications described above, the UE is also required to evaluate the radio link quality to the out-of-sync threshold called Qₒᵤₜ. The main difference between the Qₒᵤₜ and Qᵢₙ is that the former corresponds to a significantly higher hypothetical BLER target (i.e. the control channel cannot be reliably received) than the latter. In typical operation, BLER target for Qᵢₙ is 2% and Qₒᵤₜ is 10%. Another difference is that the UE sends out-of-sync indications to the higher layers only if radio link quality on all the configured RLM resources (RLM-RS) is worse than Qₒᵤₜ. The absence of out-of-sync indications (i.e. no out-of-sync is sent to the higher layer) can be interpreted as the radio link quality is stable and reliable. The number of out-of-sync indications (K2) sent by the UE to the higher layer can therefore be used as criteria for entering the relaxed RLM mode. None or limited number of out-of-sync indications may also indicate or imply that the UE has limited mobility or at least that the variation in the radio conditions of the UE is limited. Thus, operating RLM in a relaxed mode should have limited performance impact. The criteria for entering a relaxed RLM mode comprises:
   i. If UE has not sent more than K3 number of out-of-sync indications to the higher layers during T2. In one example, T2 is the RLM out-of-sync evaluation period T_{Evaluate_out}. As a special case, K3=0.
3. Radio Link Failure Timer status: The UE starts the radio link failure timer (e.g. T310) after detecting N1 (e.g. N310) out of sync indications from the lower layers for detecting physical layer problems and for preparing the UE to find alternative cells (e.g. by triggering of re-establishment procedure). Similarly, the radio link failure timer is stopped upon receiving N2 number of consecutive in-sync indications from the lower layers for the cell on which radio link monitoring is performed or upon initiating the re-establishment procedure. Upon expiry of the radio link failure timer, the UE is required to perform certain actions or tasks, such as turning off the transmitter of the UE for the monitored cell. Since the radio link failure timer is related to the radio link failure in the UE and starting or stopping of those may give an indication about the radio link quality of the monitored cell. For example, if RLF timer is started/stopped quite often it may be an indication that the radio conditions are varying and the link is not very reliable. In some cases, it may also give indication about the mobility behavior of that UE. In a similar example, if the RLF timer does not start/stop frequently, it may also mean that the radio link is stable and reliable. Therefore, it is reasonable to use information about the radio link failure timers for determining whether the UE is allowed to operate one or more RLPs in relaxed mode. The criteria for entering or operating RLPs in relaxed mode comprise:
   If RLF timer is running by the UE, or
   If RLF timer has been started by the UE over the last time duration T3. As a special case, T3 can be 0 meaning that the criterion is based on whether there is any RLF timer currently running, or
   If RLF timer has been started over last time duration T3 and not more than N3 out of sync indications have been triggered or detected in the UE.

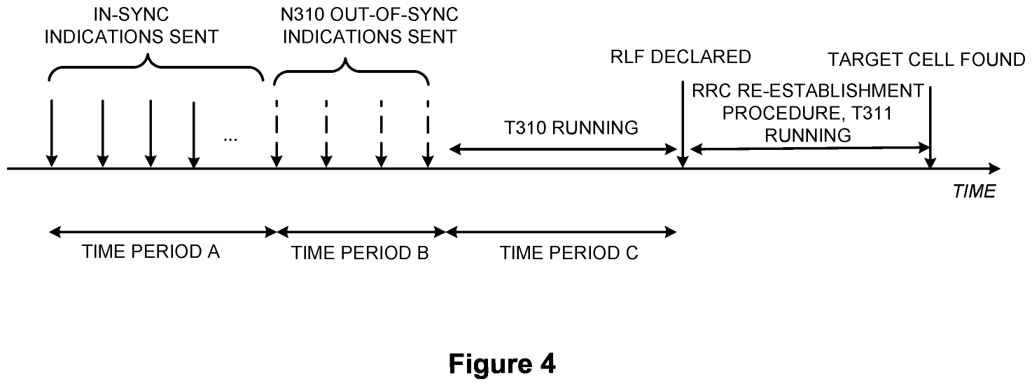

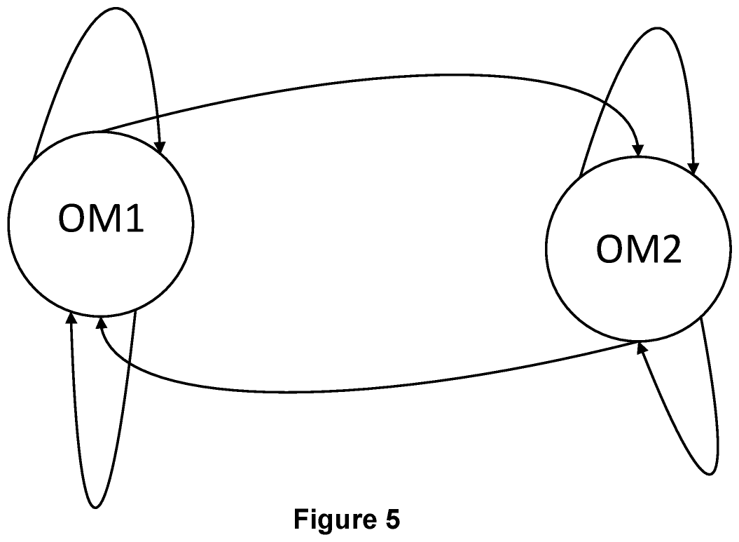

An example is shown in FIG. 4, where the UE is evaluating RLM and different RLM indications are triggered and sent to the higher layers. In this example, the UE is allowed to enter the relaxed mode during time period A because only in-sync evaluations have been triggered and this is an indication that the radio conditions (e.g. SNR level is good or SNR level is larger than a threshold) is good and link is reliable. However, the UE shall stay in normal mode and operate the RLPs according the normal procedures during time period B and C since out-of-syncs indications are triggered and RLF timer is running. This is an indication that the radio conditions are poor (e.g. SNR level has decreased or decreased more than a certain threshold).
4. Beam failure instance indications: According to the current UE behavior for beam management, the UE is required to evaluate whether the downlink radio link quality on the configured SSB resource in set q̅₀ to a predefined threshold (e.g. Q_{out_LR_SSB}) during a time duration called evaluation period (e.g. T_{Evaluate_BFD_SSB}). If the quality is better than the threshold, then the beam is considered reliable and valid. But if the quality is worse than this threshold, then the beam is considered unreliable and not valid, hence a beam failure is detected and indicated to the higher layer. The criteria for entering a relaxed mode for operating the BM comprises a condition on beam failure detection, as exemplified below.
   a. In a first example, the UE is allowed to enter in a relaxed mode for operating certain RLP (e.g. RLM, BM etc) if the UE has not done any beam failure detection over last L1 number of evaluation periods (e.g. over the last L1*T_{Evaluate_BFD}), where L1≥1 is defined as multiple of the evaluation periods used for beam failure detection. Otherwise the UE is not allowed to enter in a relaxed mode for operating that RLP or now allowed to continue operating that RLP in the relaxed mode. As special case L1=1. In other words, absence of beam failure detection can be interpreted as the current downlink radio quality is acceptable and thus the UE can be allowed to operate the RLP (e.g. BM) in a more relaxed mode.
   b. In a second example, the UE is allowed to enter a relaxed mode for operating the RLP (e.g. BM) if the UE has not done any beam failure detection over last L2 number of evaluation periods over the last time duration T1′. Otherwise the UE is not allowed to enter in a relaxed mode for operating that RLP or is now allowed to continue operating that RLP in the relaxed mode. In one example T1′=0. In another example T1′>T_{Evaluate_BFD}. This condition is more stringent the condition in previous example as it only allows RLP operation in the relaxed mode if no beam failure detection was done over the last L2 evaluation periods over last time duration T1′. Thus, this condition is considered more safe for relaxing the RLP (e.g. BM) performance than the condition in previous example.
   c. In a third example, the UE is allowed to enter a relaxed mode for operating the RLP (e.g. BM) if the UE has not done any beam failure detection over the last time duration T1″. Otherwise the UE is not allowed to enter in a relaxed mode for operating that RLP or is now allowed to continue operating that RLP in the relaxed mode.
5. Candidate beam detection: If beam failure is detected then UE is required to perform candidate beam detection (CBD) as a part of beam failure recovery (BFR) procedure. In order to find a candidate beam, the UE is required to evaluate whether the L1-RSRP and/or L1-SINR measurement performed on the configured resource (e.g. SSB resource and/or CSI-RS resource) set in q̅₁ is greater than a configurable threshold (e.g. Q_{in_LR}). The time period over which the evaluation is done is called evaluation period (e.g. T_{Evaluate_CBD_SSB}). Since the information on whether the UE was successful to find a candidate beam upon a beam failure detection indicates the radio conditions of the scenario where the UE is operating, e.g. if the UE is moving, how frequently it is moving, etc., using this information for entering a relaxed mode for operating the RLPs (e.g. BM or RLP) can improve the UE power consumption. This is exemplified in few examples below.
   a. In a first example, the UE is allowed to enter a relaxed mode for operating certain RLP (e.g. BM) if the UE has not performed candidate beam detection over the last T2′ time period. Otherwise the UE is not allowed to enter in a relaxed mode for operating that RLP or is now allowed to continue operating that RLP in the relaxed mode. As a special case, T2′=0.
   b. In a second example, the UE is allowed to enter a relaxed mode for operating certain RLP (e.g. BM) if the UE has not performed candidate beam detection over the last L2 number of candidate beam evaluation periods (e.g. over the last L2*T_{Evaluate_CBD_SSB}). Otherwise the UE is not allowed to enter in a relaxed mode for operating that RLP or is now allowed to continue operating that RLP in the relaxed mode. As a special case, L2=1.
   c. In a third example, the UE is allowed to enter a relaxed mode for operating certain RLP (e.g. BM) if the UE has not performed candidate beam detection over the last L2 number of candidate beam evaluation periods (e.g. over the last L2*T_{Evaluate_CBD_SSB}) over the last T2″ time period. Otherwise the UE is not allowed to enter in a relaxed mode for operating that RLP or is now allowed to continue operating that RLP in the relaxed mode.
   d. In a fourth example, the UE is allowed to enter a relaxed mode for operating BM if:
      i. During the last T3′ time period, the BFD has occurred, and the UE has succeeded with the CBD, i.e. UE has managed to find a candidate beam according to the current UE requirements. The value of T3′ can be fixed and expressed as multiples of the CBD evaluation period, configurable by the NW node, or pre-defined.

Otherwise the UE is not allowed to enter in a relaxed mode for operating that RLP or is now allowed to continue operating that RLP in the relaxed mode.
6. Clear Channel Assessment: The term clear channel assessment (CCA) used herein may correspond to any type of carrier sense multiple access (CSMA) procedure or mechanism which is performed by the device on a carrier before deciding to transmit signals on that carrier. The CCA is also interchangeably called CSMA scheme, channel assessment scheme, listen-before-talk (LBT) etc. The CCA based operation is more generally called contention-based operation. The transmission of signals on a carrier subjected to CCA is also called contention-based transmission. The contention-based operation is typically used for transmission on carriers of unlicensed frequency band. But this mechanism may also be applied for operating on carriers belonging to licensed band for example to reduce interference. The transmission of signals on a carrier which is not subjected to CCA is also called contention free transmission. Before a transmission or reception, the UE performs a CCA evaluation to determine whether the channel is free and allowed to transmit if it is free. If evaluation has resulted in CCA failure, then it means the UE cannot perform the intended operation in that radio source (e.g. transmission or reception). In this case the UE will have to try again later in time when the CCA evaluation has resulted in a success. In other words, if there is large number of CCA failures during a certain period, then the UE may have to stay awake and try again to perform the intended operation at later point in time. In one example of the embodiment the UE is allowed to enter in a relaxed mode if the UE has not detected large number of CCA failures in the downlink (DL) in the BS and/or in the UL in the UE for receiving and/or transmitting signals respectively on a carrier subject to CCA; otherwise the UE is not allowed to enter in a relaxed mode or not allowed to continue operating in relaxed mode (if it was already in relaxed mode). In one specific example the UE is allowed to enter in a relaxation mode for operating RLPs provided that the number (K41) of DL CCA failures over last T41 duration do not exceed certain threshold (Hcd) and/or the number (K42) of UL CCA failures over last T42 duration do not exceed certain threshold (Hcu); otherwise the UE is not allowed to enter in a relaxed mode or not allowed to continue operating in relaxed mode (if it was already in relaxed mode). The parameters Hcd, Hcu, T41 and T42 can be configured by the network node or can be pre-defined. The UE can detect DL CCA failures in the BS autonomously (e.g. be sensing the absence of signals) and/or by receiving an explicit indication from the NW node indicating time resources where the CCA failed.
7. Wake up signal configuration: The wake up signal (WUS) can have different configurations. One type of configuration or mapping is 1×1, which means there is a WUS signal transmitted prior to every paging or DRX ON if WUS is configured. This means in the beginning of every DRX ON duration the UE will attempt to receive the WUS and based on the information conveyed in the WUS, UE will remain awake and receive the control channel or it may go to sleep. Another type of configuration or mapping is 1×N, in this case one WUS is related to multiple POs or DRX ON durations. The WUS information can be used by the UE for determining whether it shall operate the RLPs in relaxed mode. For example, if UE is configured by the WUS to sleep for a certain number of DRX ON durations, then it might be the indication that the UE is not expected to be scheduled for the same time duration, or that the mobility is limited, or it may not be transmitting and/or receiving a lot of data in active state. Thus, UE is allowed to enter the relaxation mode. On the other hand if the WUS configuration is changed such that it requires the UE to wake up more frequently prior to DRX ON, then this information can be used by the UE to exit the relaxation mode if it is already operating in the relaxation mode and operate the RLP in the normal mode instead, or it may be used by the UE to not enter in to relaxation mode.
8. Configuration of certain measurement type(s): If the UE is configured to perform one or more particular types of measurements. One example of particular type of measurement is the measurement performed for particular purpose e.g. critical operation such as emergency services, positioning etc. Another example of particular type of measurement is the measurement performed using certain types of reference signals e.g. positioning reference signals. This is further elaborated with examples below. For example, assume that the UE determines the need to perform certain measurement type (called herein as a first measurements) on a first type of discovery reference signals (DRS1) of one or more cells belonging to a serving carrier (F1). Examples of DRS1 are positioning reference signal (PRS), positioning sounding reference signal (SRS) etc. The BW of DRS1 is configurable and it is up to the network node whether to transmit DRS1 over full or partial BW of the cell. Examples of serving carrier are anchor-carrier, non-anchor carrier, primary carrier or primary component carrier (PCC), secondary component carrier (SCC) etc. In one example, the determining is based on one or more of: a request to perform such measurements, a request to report such measurements, a request to perform and/or report a result based on such measurements (e.g., cell change, location calculation, etc.), a measurement configuration, etc., which may be received from another node (e.g., a network node) or from a higher layer. In another example, the determining is based on the fact that UE location has changed more than a certain margin compared to previously determined or known location. Examples of the first measurements: positioning measurements such as RSTD measurements, UE Rx-Tx measurement, PRS-RSRP etc. Generally, the positioning measurements are more time critical than RRM measurements (e.g. used for mobility) and therefore may have higher priority than the UE power saving procedure. Therefore, in one example the UE is only allowed to enter in the relaxed mode if the UE is not configured to perform specific types of measurements (e.g. positioning measurements such as RSRP, UE Rx-Tx, PRS-RSRP etc) as described above.
9. Operation of certain signals: If the UE is operating one or more particular type of signals/channels then it may not be allowed to enter in the relaxed operational mode for the RLPs; otherwise the UE is allowed to enter in a relaxed mode or continue operating in relaxed mode (if it was already in relaxed mode). In one specific example the UE allowed to enter in the relaxed operational mode for the RLPs provided that the UE has not been operating one or more particular signals in the last T5 time period; otherwise the UE is not allowed to enter in the relaxed mode or continue operating in relaxed mode. Operation herein comprising one or both of: receiving signals/channels in downlink from a node (e.g. NW node) and transmitting signal/channels in uplink. The reception and transmission of signals may also be called as scheduling of signals in DL and in UL respectively. The reception and transmission of signals may also be required by the UE for performing particular procedures e.g. switching of beam for receiving and/or transmitting signals, active transmission configuration indicator (TCI) state switching etc. Examples of particular type of signals/channels are: transmission of SRS, PUSCH, PUCCH, PRACH, reception of downlink reference signals or channels (e.g. PDCCH).

Examples of switching between different modes according to embodiments are also described. Based on the above criteria (at least one in S1 and one in S2) the UE will switch operation of certain RLP (or combination of RLPs) in one of the two modes and perform the RLP(s) in the new mode. A generic example comprising UE switching between the current operational mode, OM1 and the new operational mode, OM2 is shown in FIG. 5. As explained above, each OM is associated with one or more criteria in S1 and one or more criteria in S2. UE switches from one OM to another only if it has fulfilled the criteria associated with the target OM. Otherwise, it will remain in the current OM. In one example OM1 is NM and OM2 is relaxed mode. In second example OM1 is relaxed mode and OM2 is normal mode (NM).

The method of switching from OM1 to OM2 assuming OM1 and OM2 are normal mode and relaxed mode are explained using few specific examples. In this case the UE in normal mode evaluates one or more criteria in S1 and one or more criteria in S2. The UE is allowed to enter in relaxed mode only when one or more criteria is met in S1 and one or more criteria is met in S2.

The difference between the normal operational mode (e.g. legacy mode) and the relaxed operating mode is that the latter mode is associated with one or more relaxed requirements compared to the corresponding requirements associated with the former mode. The term ‘relaxed requirements’ or ‘more relaxed requirements’ may also be called as less stringent requirement. In one example relaxed measurement period or relaxed evaluation period of the RLP is longer wrt reference period. The reference period is one of the requirements to be met by the UE when performing RLP in normal operational mode. For example, OOS evaluation period for RLM procedure under relaxed mode and normal mode comprising T1′ and T1 time resources respectively; where T1′=K*T1 and K is a scaling factor. As an example, K=4. In another example the absolute value of the measurement accuracy of the RLP related measurement (e.g. L1-RSRP or L1-SINR) can be larger wrt magnitude of reference accuracy level etc. The reference accuracy is one of the requirements to be met by the UE when performing RLP in normal mode. For example, L1-RSRP accuracy for BM procedure under relaxed mode and normal mode comprising ±4 dB and ±2 dB wrt the correct L1-RSRP value, respectively. In a third example, the periodicity for sending the RLP indications (e.g. in-sync indication, out-of-sync indication) to the higher layers can be relaxed. Example of such periodicity is T_{Indication_interval}. In one specific example related to RLM, if the UE is operating RLPs in a relaxed mode, then UE can be required to send RLM indications to the higher layers, such indications are separated by 4×T_{Indication_interval} when operating in relaxed mode compared to every T_{Indication_interval} when operating in normal mode.

For example, the relaxation of the evaluation period can be realized by scaling (e.g. extending) the reference evaluation period with a scaling factor which may depend on several factors such as UE mobility, wake-up-signal (WUS) configuration, DRX configurations etc. The criteria may also interchangeably be called as rules or conditions. Specific examples of switching from the normal mode to the relaxed mode for different RLPs are described below. Example 1 below describes one example of the method that can be specified in a specification for performing RLM in a relaxed mode where the criteria for operating in a relaxed mode is evaluated and determined by the NW node. In this example condition #1 belongs to set S1 and other conditions (conditions #2-7) belong to set S2.

### EXAMPLE 1

### 8.1.X Requirements for Relaxed SSB Based Radio Link Monitoring

### 8.1.X.1 Introduction

The requirements in this clause apply for each SSB based RLM-RS resource configured for PCell or PSCell, provided that the SSB configured for RLM is actually transmitted within UE active DL BWP during the entire evaluation period specified in clause 8.1.2.2 in TS 38.133 and provided the following conditions are fulfilled:
1. UE is configured with relaxed RLM criterion using IE relaxedSSB-RLM,
2. UE has sent more than K1 in-sync indications to the higher layer during last T1 time period
3. UE has not sent more than K2 out-of-sync indications to the higher layer during last T2 time period
4. T310 timer is not running
5. UE is not configured to perform positioning measurements
6. UE has not triggered beam failure instance during last T3 time period
7. UE has not detected more than M1 number of CCA failures during last T4 time period

### 8.1.X.2 Minimum Requirements

The requirements defined in clause 8.1.2.2 in TS 38.133 apply for this section except that:
the new evaluation period T_{Evaluate_out_SSB-Relaxed} is specified as K11*T_{Evaluate_out_SSB}, where T_{Evaluate_out_SSB} is as specified in clause 8.1.3.2 in TS 38.133 .
the new indication period T_{Indication_interval-Relaxed} is specified as K21*T_{Indication_interval} where T_{Indication_interval} is as specified in clause 8.1.6 in TS 38.133.

Example 2 below describes one example of the method that can be specified in a specification (e.g. 3GPP TS38.133) for performing RLM in a relaxed mode where the criteria for operating in a relaxed mode is evaluated and determined by the UE. The difference between example 1 and example 2 is that in the latter case, UE is evaluating and determining whether it is operating in low mobility scenario while it was done by the NW node itself in the former example. This determination can be based on one or more configured or pre-defined criteria (e.g. it could depend on Srxlev, Squal, relative changes of Srxlev, Squal, or comparison of Srlev and Squal to different thresholds). In this example conditions #1 and #2 belong to set S1 and other conditions (conditions #3-8) belong to set S2.

### EXAMPLE 2

### 8.1.X Requirements for Relaxed SSB Based Radio Link Monitoring

### 8.1.X.1 Introduction

The requirements in this clause apply for each SSB based RLM-RS resource configured for PCell or PSCell, provided that the SSB configured for RLM is actually transmitted within UE active DL BWP during the entire evaluation period specified in clause 8.1.2.2 in TS 38.133 and provided the following conditions are fulfilled:
1. UE is configured with relaxed RLM criterion using IE relaxedSSB-RLM,
2. UE has fulfilled the low mobility criterion
3. UE has sent more than K1 in-sync indications to the higher layer during last T1 time period
4. UE has not sent more than K2 out-of-sync indications to the higher layer during last T2 time period
5. T310 timer is not running
6. UE is not configured to perform positioning measurements
7. UE has not triggered beam failure instance during last T3 time period
8. UE has not detected more than M1 number of CCA failures during last T4 time period

### 8.1.X.2 Minimum Requirements

The requirements defined in clause 8.1.2.2 in TS 38.133 apply for this section except that:
the new evaluation period T_{Evaluate_out_SSB-Relaxed} is specified as K12*T_{Evaluate_out_SSB}, where T_{Evaluate out SSB is as specified in clause} 8.1.3.2 in TS 38.133.
the new indication period T_{Indication_interval-Relaxed} is specified as K22*T_{Indication_interval} where T_{Indication interval is as specified in clause} 8.1.6 in TS 38.133.

Example 3 below describes one example of the method that can be specified in a specification for performing BM in a relaxed mode where the criteria for operating in a relaxed mode is evaluated and determined by the NW node. In this example condition #1 belongs to set S1 and other conditions (conditions #2-3) belong to set S2.

### EXAMPLE 3

### 8.5.x Relaxed Link Recovery Procedures

### 8.5.x.1 Introduction

The UE shall assess the downlink radio link quality of a serving cell based on the reference signal in the set q̅₀ as specified in TS 38.213 in order to detect beam failure on:
PCell in SA, NR-DC, or NE-DC operation mode,
PSCell in NR-DC and EN-DC operation mode,

This relaxed link recovery procedures specified in this clause apply provided that:
1. UE is configured with relaxed link recovery procedures,
2. UE has not reported beam failure instance for last T4 period,
3. UE has reported beam failure instance, but it has reported a detected beam according to the candidate beam detection procedure.

### 8.5.x.2 Minimum Requirement

The requirements defined in clause 8.5.2.2 in TS 38.133 apply for this section except that:
the new evaluation period T_{Evaluate_BFD_SSB-Relaxed} is specified as K13*T_{Evaluate_BFD_SSB}, where T_{Evaluate_BFD_SSB} is as specified in clause 8.5.3.2 in TS 38.133.
the new indication period T_{Indication_interval_BFD-Relaxed} is specified as K23*T_{Indication_interval_BFD} where T_{Indication_interval_BFD} is as specified in clause 8.5.4 in TS 38.133.

Example 4 below describes one example of the method that can be specified in a specification for performing BM in a relaxed mode where the criteria for operating in a relaxed mode is evaluated and determined by the UE. The difference between example 3 and example 4 is that in the latter case, UE is evaluating and determining whether it is operating in low mobility scenario while it was done by the NW node itself in the former example. This determination can be based on one or more configured or pre-defined criteria (e.g. it could depend on Srxlev, Squal, relative changes of Srxlev, Squal, or comparison of Srlev and Squal to different thresholds). In this example conditions #1 and #2 belong to set S1 and other conditions (conditions #3-4) belong to set S2.

### EXAMPLE 4

### 8.5.x Relaxed Link Recovery Procedures

### 8.5.x.1 Introduction

The UE shall assess the downlink radio link quality of a serving cell based on the reference signal in the set q̅₀ as specified in TS 38.213 in order to detect beam failure on:
PCell in SA, NR-DC, or NE-DC operation mode,
PSCell in NR-DC and EN-DC operation mode.

This relaxed link recovery procedures specified in this clause apply provided that:
1. UE is configured with relaxed link recovery procedures,
2. UE has fulfilled the low mobility criterion
3. UE has not reported beam failure instance for last T4 period,
4. UE has reported beam failure instance, but it has reported a detected beam according to the candidate beam detection procedure.

### 8.5.x.2 Minimum Requirement

The requirements defined in clause 8.5.2.2 and in clause 8.1.5.2 in TS 38.133 apply for this section except that:
the new evaluation period T_{Evaluate_BFD_SSB-Relaxed} is specified as K14*T_{Evaluate_BFD_SSB}, where T_{Evaluate_BFD_SSB} is as specified in clause 8.5.3.2 in TS 38.133.
the new indication period T_{Indication_interval_BFD-Relaxed} is specified as K24*T_{Indication_interval_BFD} where T_{Indication_interval_BFD} is as specified in clause 8.5.4 in TS 38.133.

Example 5 below describes one example of the method that can be specified in a specification for performing BM in a relaxed mode where the criteria for operating in a relaxed mode is evaluated and determined by the UE. Compared to previous examples, it contains more criteria in set S2. In this example conditions #1 and #2 belong to set S1 and other conditions (conditions #3-8) belong to set S2.

### EXAMPLE 5

### 8.5.x Relaxed Link Recovery Procedures

### 8.5.x.1 Introduction

The UE shall assess the downlink radio link quality of a serving cell based on the reference signal in the set q̅₀ as specified in TS 38.213 in order to detect beam failure on:
PCell in SA, NR-DC, or NE-DC operation mode,
PSCell in NR-DC and EN-DC operation mode.

This relaxed link recovery procedures specified in this clause apply provided that:
1. UE is configured with relaxed link recovery procedures,
2. UE has fulfilled the low mobility criterion
3. UE has not reported beam failure instance for last T4 period,
4. UE has reported beam failure instance, but it has reported a detected beam according to the candidate beam detection procedure.
5. UE has sent more than K1 in-sync indications to the higher layer during last T1 time period
6. UE has not sent more than K2 out-of-sync indications to the higher layer during last T2 time period
7. T310 timer is not running
8. UE is not configured to perform positioning measurements

### 8.5.x.2 Minimum Requirement

The requirements defined in clause 8.5.2.2 and in clause 8.1.5.2 in TS 38.133 apply for this section except that:
the new evaluation period T_{Evaluate_BFD_SSB-Relaxed} is specified as K15*T_{Evaluate_BFD_SSB}, where T_{Evaluate_BFD_SSB} is as specified in clause 8.5.3.2 in TS 38.133.
the new indication period T_{Indication_interval_BFD-Relaxed} is specified as K25*T_{Indication_interval_BFD} where T_{Indication_interval_BFD} is as specified in clause 8.5.4 in TS 38.133.

As discussed above, the UE uses the result of the evaluation for operating tasks. In some embodiments, the UE uses the result of the evaluation for operating tasks which comprise one or more of the following:
Operating the RLP in a certain mode while meeting the UE requirements for that RLP associated with that mode. For example, if the UE is operating the RLP in a relaxed mode then the UE measures, evaluates and/or report measurement results less frequently and/or over longer period compared to the case when the UE performs RLP in the normal mode. The reporting herein comprises reporting to a third node, but also reporting internally to higher layers.
Informing the network node about OM1 and/or OM2 (current/new) operational mode(s), e.g. when switching from one mode to another.

The present disclosure also describes methods performed by the UE for performing RLPs in a relaxed mode when subset of RLPs meet criteria according to some embodiments. This embodiment is applicable for the scenario when the UE is configured to perform two or more RLPs (e.g. RLM, BM etc) on the same cell (e.g. on SpCell such as PCell) but the UE meets criteria (e.g. one criterion in S1 and one criterion in S2) only for subset of the configured RLPs in the relaxed mode. For example, the UE may meet criteria for performing RLM in relaxed mode but not for BM on the same cell e.g. on SpCell. In another example the UE may meet criteria for performing BM in relaxed mode but not for RLM on the same cell e.g. on SpCell.

For simplicity the RLPs configured on the same cell may be called as conjoint RLPs or conjoint set, associated RLPs, related RLPs etc. Furthermore, the RLPs among the conjoint RLPs meeting criteria for relaxed mode may be called as ‘qualified’ RLPs while those in the conjoint set not meeting the criteria for relaxed mode may be called as ‘unqualified’ RLPs. This embodiment provides rules according to which the UE may further be allowed to perform ‘unqualified’ RLPs in relaxed mode. This may be allowed to enable sufficient UE power saving or when the UE is not expected to be served. For example the UE may be configured (e.g. pre-defined or configured by NW node) with low mobility criterion in S1 for two RLPs (e.g. RLM and BM) but different criterion in S2 e.g. OOS detection related criterion for RLP1 (e.g. RLM) and beam failure indication related criterion for RLP2 (e.g. BM). In this example S1 criterion is met for both RLPs for operating in relaxed mode but S2 criterion is met only for RLP1 (e.g. RLM) and not for RLP2 (e.g. BM). This means the UE can perform RLP1 in relaxed mode (as explained in embodiment #1), whether the UE can also perform RLP2 in relaxed mode, will depend on the rule. The rules can be pre-defined or configured by the network node. The rules are explained with few examples described below.
1. Based on configuration: In one example of rule, if at least one RLP meets the criteria for relaxed mode, then the UE is further configured whether UE is allowed to perform the other RLPs in relaxed mode, or not. The UE can further be configured which specific RLP can be relaxed even if does not meet the criteria for relaxation. In one specific example if at least one RLP meets the criteria for relaxed mode, then the UE is also allowed to perform the other RLPs also in relaxed mode even if they don't meet the criteria for relaxed mode. Table 1 illustrates an example rule showing that if RLP2 meets the criteria for the relaxed mode then the UE is allowed to perform RLP1 in relaxed mode but not the other way around. In another example, Table 2 illustrates an example rule illustrating that if RLP1 meets the criteria for the relaxed mode then the UE is allowed to perform RLP2 in relaxed mode but not the other way around. The configuration of the scenarios in which when only subset of RLPs meets the criteria but other RLPs are also allowed in relaxed mode can be pre-defined or configured by the network node.

TABLE 1
2. Example rule showing both relaxed RLM and relaxed BM are
allowed when RLP meets criteria for relaxation

| | RLP1 | | |
|---|---|---|---|
| | (e.g. | | |
| Scenario#ID | RLM) | RLP2 (e.g. BM) | Status of RLPs |
| 0 | 0 | 1 | Both RLP1 and RLP2 are relaxed |
| 1 | 1 | 0 | Only RLP1 is relaxed |

0 = RLP does not meet criteria for relaxed mode;
1 = RLP meets criteria for relaxed mode

TABLE 2
Example rule showing both relaxed RLM and relaxed BM are
allowed when RLP1 meets criteria for relaxation

| | RLP1 | | |
|---|---|---|---|
| | (e.g. | | |
| Scenario#ID | RLM) | RLP2 (e.g. BM) | Status of RLPs |
| 0 | 0 | 1 | Only RLP2 is relaxed |
| 1 | 1 | 0 | Both RLP1 and RLP2 are relaxed |

0 = RLP does not meet criteria for relaxed mode;
1 = RLP meets criteria for relaxed mode

3. Based on the relation between resources configured for RLM and BM: Whether the UE is allowed to enter an operational mode where it is allowed to perform all RLPs in relaxed mode (e.g. both relaxed RLM and relaxed BM) depends on the relation (R) between the resources (or group of resources, or resource set) over which the RLPs are performed e.g. resources on which RLP1 (e.g. RLM) is performed and RLP2 (e.g. BM) is performed. In one specific example, the resources over which RLM is performed is called RLM-RS, which is a resource out of a set of resources configured for RLM by the higher layer. The resources over which BM is performed is called resource set, BM-RS resource configuration. In one specific example, the resources over which the BM is performed is the configured BM-RS resources in the resource set (called). For simplicity, the resources used for RLM is called R1 and resources used for BM is called R2, and the relation can be expressed using a function:

R=f(R1,R2);
where R1 and R2 can be related in different manner e.g. fully overlapping, non-overlapping or partially overlapping in frequency and time domain, same, similar or different periodicities etc.
In a first example, R1 and R2 can be non-overlapping, i.e. they are not overlapping neither in time domain nor in frequency domain meaning that the reference signals are transmitted over different time periods and different frequency resources.
In a second example, R1 and R2 can be partially overlapping meaning that some of the resources configured for RLM and BM are transmitted over the same time period. It may also mean that R1 is same as R2, or R1 is subset of R2 or R2 is a subset of R1.
In a third example, R1 and R2 can be fully overlapping (e.g. in time-domain, or frequency domain, or both time- and frequency-domain). In this case, R1 can be same as R2, i.e. both RLM and BM are performed over the same set of resources.
In a fourth example, R1 and R2 are configured with the periodicities, P1 and P2, respectively which are within certain margin (Δp1). As an example, Δp=20 ms. As special case Δp=0 i.e. P1=P2 e.g. P1=P2=80 ms.
In a fifth example, R1 and R2 are configured with the periodicities, P1 and P2, respectively which are larger than certain margin (Δp2). Example of Δp2 is 40 ms. In one example P1=20 ms and P2=80 ms and in another example P1=160 ms and P2=20 ms.

Based on the relation between R1 and R2, the UE can be allowed to perform both RLM and BM in a relaxed mode even if one of the RLPs does not meet the criteria for the relaxation. Assume that only RLP1 (e.g. RLM) meets the criteria for operating in relaxed mode but not RLP2 (e.g. BM). In one example, the UE can be allowed to perform both RLM and BM in relaxed mode when the resources are fully overlapping (as in third example); otherwise the UE is not allowed to perform RLP2 in relaxed mode. As a special case, UE can be allowed to enter the relaxed mode for both RLM and BM in the second example where only some of the resources are overlapping; otherwise the UE is not allowed to perform RLP2 in relaxed mode. In another example, the UE can be allowed to perform both RLPs (e.g. RLM and BM) in relaxed mode if P1 and P2 are the same periodicities or are within certain margin (4^{th} example); otherwise the UE is not allowed to perform RLP2 in relaxed mode. In yet another example, the UE can be allowed to perform both RLM and BM in relaxed mode if P1 is longer than P2 by certain margin (e.g. 40 ms); otherwise the UE is not allowed to perform RLP2 in relaxed mode.
4. Based on reference RLP meeting criteria: whether the UE is allowed to enter an operational mode where it is allowed to perform both RLPs in relaxed mode (e.g. both relaxed RLM and relaxed BM) depends on the status of the reference RLP even if one of the RLPs does not meet the criteria for the relaxation. In this case, it is assumed that UE is configured with a group of RLPs wherein one is configured as a reference RLP. The reference RLP can be pre-defined, configured by the network node or determined by the UE autonomously. If the UE has fulfilled the criteria for entering a relaxed mode for operating the reference RLP, then UE can be allowed to operate the other RLPs also in relaxed mode regardless of whether or not they have fulfilled the relaxation criteria. However, if UE has not fulfilled the criteria for entering a relaxed mode for operating the reference RLP then the UE has to evaluate the criteria for the other RLPs separately. In one example reference RLP is RLM, while in another example RLP is BM
5. Based on frequency characteristics of cell: whether the UE is allowed to enter an operational mode where it is allowed to perform both RLPs in relaxed operational mode (e.g. relaxed RLM and relaxed BM) depends on the frequency characteristics. Examples of the frequency characteristics comprising: the frequency range (FR) of the resources over which the RLPs are performed (e.g. if RLM-RS, BM-RS etc are performed on a cell belonging to FR1, FR2, etc.), if the said resources are configured over carrier frequencies below certain frequency threshold(s) (Hf) or between certain frequency thresholds (Hf1 and Hf2). For example if the UE is configured to perform two or more RLPs (e.g. RLM and BM) on cell operating on carrier belonging to certain FR (e.g. FR2) then if criteria for performing one RLP (e.g. RLP1) in relaxed mode is met then the UE is also allowed to perform the other RLP (e.g. RLP2) in relaxed mode. But if the UE is configured to perform both two or more RLPs (e.g. RLM and BM) on cell operating on carrier belonging to another FR (e.g. FR1) then if criteria for performing RLP1 in relaxed mode is met but not for RLP2, then the UE is not allowed to perform RLP2 in relaxed mode. Examples of FR1 comprising frequencies between 400 MHz and 7 GHz, and of FR2 comprising frequencies between 24 GHz and 52.6 GHz.

The principle is exemplified for two RLPs where one meets the criteria for entering a relaxed operation mode, but not the other. It shall be noted that the same principle can be applied for any number of RLPs.

The UE may further operate the conjoint RLPs according to the determined modes while meeting the UE requirements for all the RLPs associated with their respective modes. For example, if the UE is operates the RLP1 and RLP2 in a relaxed mode then the UE measures, evaluates and/or report measurement results less frequently and/or over longer period compared to the case when the UE performs those RLPs in the normal mode. The UE may further inform the network node about OM1 and/or OM2 (current/new) operational mode(s) for the conjoint RLPs, e.g. when switching from one mode to another.

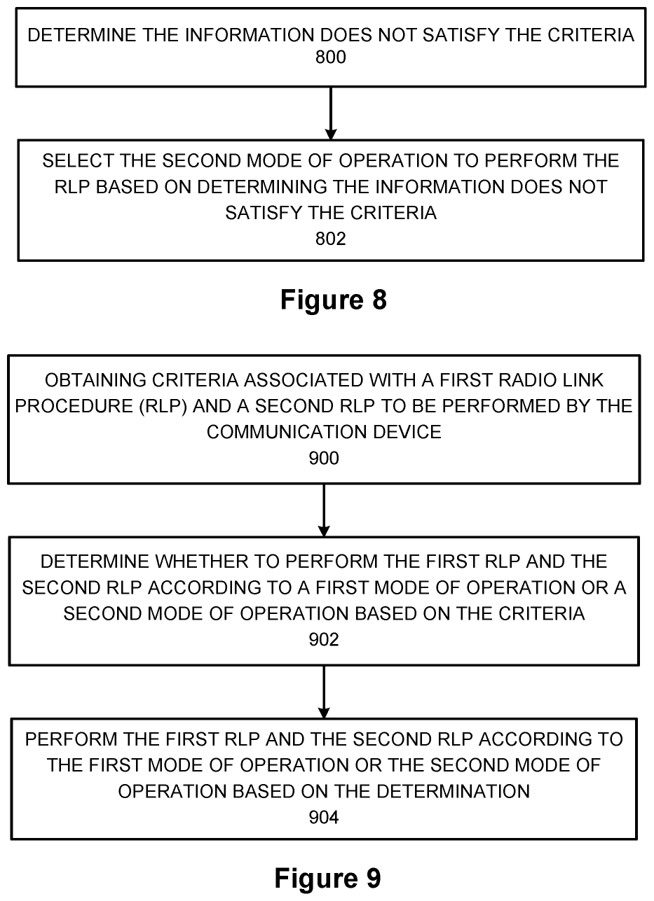

Operations of the communication device 100 (implemented using the structure of the block diagram of FIG. 1) will now be discussed with reference to the flow chart of FIGS. 8-14 according to some embodiments of the present disclosure. For example, modules may be stored in memory 105 of FIG. 1, and these modules may provide instructions so that when the instructions of a module are executed by respective communication device processing circuitry 103, processing circuitry 103 performs respective operations of the flow chart.

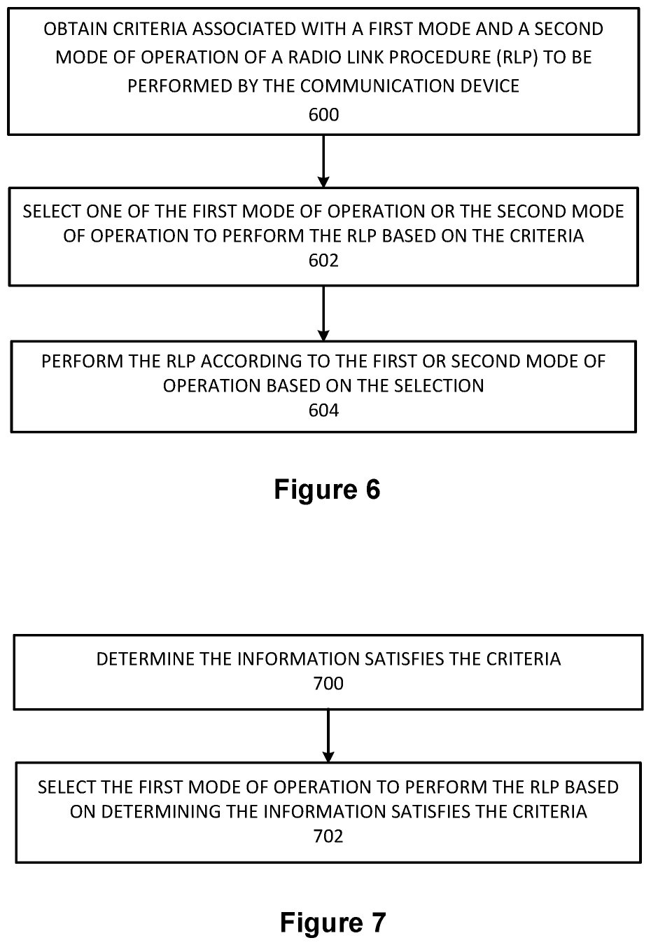

FIG. 6 illustrates a method performed by a communication device 100 according to some embodiments of the present disclosure. FIG. 6 illustrates the method includes obtaining 600 criteria associated with a first mode and a second mode of operation of a Radio Link Procedure (RLP) to be performed by the communication device. For example, communication device 100 obtains criteria associated with a first mode and a second mode of operation of an RLP to be performed by communication device 100. FIG. 6 also illustrates the method includes selecting 602 one of the first mode of operation or the second mode of operation to perform the RLP based on the criteria and performing 604 the RLP according to the first or second mode of operation based on the selection. Continuing the previous example, communication device 100 selects one of the first mode of operation or the second mode of operation to perform the RLP based on the criteria and performs the RLP according to the first or second mode of operation based on the selection.

In some embodiments, the criteria comprises a first set of criteria that is associated with a scenario in which the communication device is able to perform the RLP according to the first mode of operation. The scenario in which the communication device is able to perform the RLP according to the first mode of operation comprises one or more of a speed of the communication device and a location of the communication device in a cell of a wireless network. The criteria also a second set of criteria that is associated with a condition that impacts performance of the RLP when operating the RLP according to the first mode of operation in some embodiments. The condition that impacts performance of the RLP when operating the RLP according to the first mode of operation comprises one or more of a beam failure detection, an in-sync (IS) detection, an out-of-sync (OOS) detection, a candidate beam detection, and a radio link failure trigger. Additional examples and embodiments of conditions and scenarios associated with the criteria are described herein above.

The method includes obtaining the criteria from a network node via higher layer signaling according to some embodiments. For example, communication device 100 obtains the criteria from one of RAN node 200 or CN node 300, or a combination thereof. In some other embodiments, the communication device is pre-configured with the criteria and the criteria is obtained from a storage device of the communication device. For example, communication device 100 is pre-configured with the criteria and obtains the criteria from memory 105. In some embodiments, memory 105 may comprise SIM device as discussed herein above.

In some embodiments, the method includes obtaining the criteria in response to the communication device one of entering a cell of a wireless network for the first time or performing a cell change in the wireless network. For example, communication device 100 may obtain the criteria in response to communication device 100 one of entering a cell of a wireless network for the first time or performing a cell change in the wireless network. In another embodiment, the method includes obtaining the criteria in response to the communication device switching between Radio Resource Control (RRC) states. In another example, communication device 100 may obtain the criteria in response to communication device 100 switching between RRC states. In yet another embodiment, the method includes obtaining the criteria upon receiving an explicit request from a network node or based on an internal trigger within the communication device. For example, communication device 100 obtains the criteria upon receiving an explicit request from one of RAN node 200 or CN node 300. In another example, communication device 100 obtains the criteria based on an internal trigger within communication device 100.

According to embodiments, the first mode of operation comprises a relaxed mode of operation to perform the RLP and the second mode of operation comprises a normal mode of operation to perform the RLP. In some embodiments, the relaxed mode of operation comprises one or more of a relaxed measurement period that exceeds a normal measurement period of the normal mode of operation, a relaxed reference signal measurement accuracy level that exceeds a reference signal measurement accuracy level of the normal mode of operation, a relaxed periodicity for sending RLP indications that exceeds a normal periodicity for sending RLP indications of the normal mode operation, and/or a relaxed evaluation period that extends the normal evaluation period of the normal mode of operation. Additional examples of relaxed modes of operation and normal modes of operation of an RLP are discussed herein above. In some embodiments, the RLP comprises one of Radio Link Monitoring (RLM) procedure and a Beam Management (BM) procedure. Additional examples of Radio Link Procedures are also discussed herein above.

The method includes obtaining information associated with the communication device operating within a cell of a wireless network according to some embodiments. For example, the communication device 100 may obtain information associated with communication device 100 operation within a cell of a wireless network. Different examples of the information obtained by the communication device are also described herein above.

FIG. 7 illustrates the method includes determining 700 the information satisfies the criteria and selecting 702 the first mode of operation to perform the RLP based on determining the information satisfies the criteria in one embodiment. For example, communication device 100 determines information satisfies the criteria and selects the first mode of operation to perform the RLP based on determining the information satisfies the criteria. In this example, the first mode of operation may comprise a relaxed mode of operation of the RLP.

FIG. 8 illustrates the method includes determining 800 the information does not satisfy the criteria and selecting 802 the second mode of operation to perform the RLP based on determining the information does not satisfy the criteria. For example, communication device 100 determines the information does not satisfy the criteria and selects the second mode of operation to perform the RLP based on determining the information does not satisfy the criteria. In this example, the second mode of operation may comprise a normal mode of operation of the RLP.

In some embodiments, the information comprises measurement data obtained by the communication device performing one or more measurements on a signal operating between the communication device and the cell. In this embodiment, the method includes selecting one of the first mode of operation or the second mode of operation to perform the RLP based on the criteria and the measurement data. For example, the communication device 100 obtains measurement data by performing one or more measurements on a signal operating between the communication device and the cell. The communication device 100 then selects one of the first mode of operation or the second mode of operation to perform the RLP based on the criteria and the measurement data.

FIG. 9 illustrates a method performed by a communication device according to some embodiments of the present disclosure. FIG. 9 illustrates the method includes obtaining 900 criteria associated with a first Radio Link Procedure (RLP) and a second RLP to be performed by the communication device. The method also includes determining 902 whether to perform the first RLP and the second RLP according to a first mode of operation or a second mode of operation based on the criteria. For example, communication device 100 obtains criteria associated with a first RLP and a second RLP to be performed by communication device 100. Communication device 100 also determines whether to perform the first RLP and the second RLP according to a first mode of operation or a second mode of operation based on the criteria. FIG. 11 further illustrates the method includes performing 904 the first RLP and the second RLP according to the first mode of operation or the second mode of operation based on the determination. Continuing the previous example, communication device 100 performs the first RLP and the second RLP according to the first mode of operation or the second mode of operation based on the determination.

In some embodiments, first RLP comprises a Radio Link Monitoring (RLM) procedure and the second RLP comprises a Beam Management (BM) procedure. In some embodiments, the criteria comprises a first set of criteria that is associated with a scenario in which the communication device is able to perform the first RLP and the second RLP according to the first mode of operation. The scenario in which the communication device is able to perform the first RLP and the second RLP comprises one or more of a speed of the communication device and a location of the communication device in a cell of a wireless network. In some embodiments, the criteria comprises a second set of criteria that is associated with a condition that impacts performance of the first RLP and the second RLP when operating the first RLP and the second RLP according to the first mode of operation. The condition that impacts performance of the first RLP and the second RLP comprises one or more of a beam failure detection, an in-sync (IS) detection, an out-of-sync (OOS) detection, a candidate beam detection, and a radio link failure trigger.

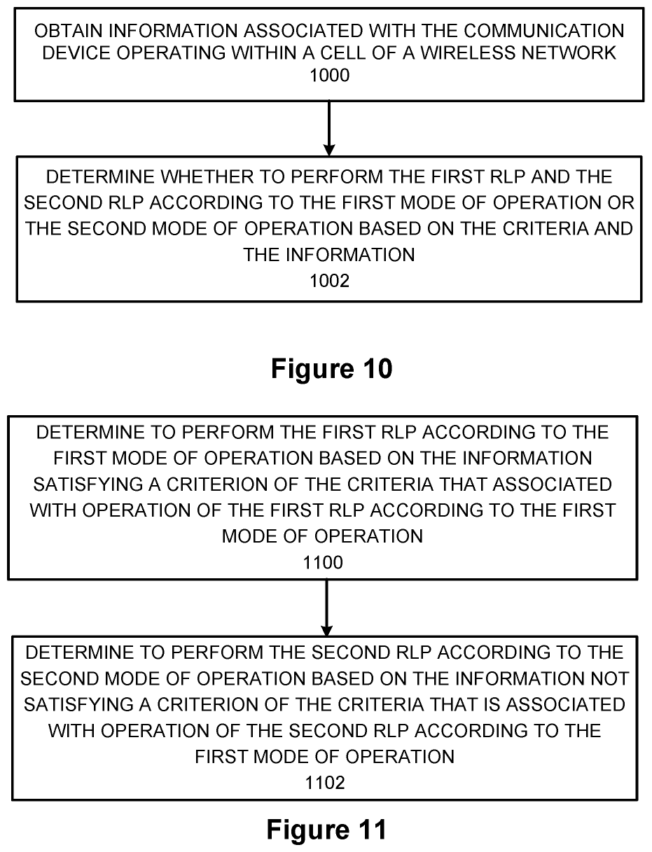

FIG. 10 illustrates the method includes obtaining 1000 information associated with the communication device operating within a cell of a wireless network and determining 1002 whether to perform the first RLP and the second RLP according to the first mode of operation or the second mode of operation based on the criteria and the information. For example, communication device 100 obtains information associated with the communication device operating within a cell of a wireless network and determines whether to perform the first RLP and the second RLP according to the first mode of operation or the second mode of operation based on the criteria and the information. Different examples of the information obtained by the communication device are also described herein above.

In one embodiment, FIG. 11 illustrates the method includes determining 1100 to perform the first RLP according to the first mode of operation based on the information satisfying a criterion of the criteria that associated with operation of the first RLP according to the first mode of operation. In this embodiment the method also includes determining 1102 to perform the second RLP according to the second mode of operation based on the information not satisfying a criterion of the criteria that is associated with operation of the second RLP according to the first mode of operation as illustrated in FIG. 11. For example, the communication device 100 determines to perform the first RLP according to the first mode of operation based on the information satisfying the criterion of the criteria that associated with operation of the first RLP according to the first mode of operation and determines to perform the second RLP according to the second mode of operation based on the information not satisfying a criterion of the criteria that is associated with operation of the second RLP according to the first mode of operation. Additional examples and embodiments regarding operation of multiple RLPs according to different modes of operation within a cell are discussed herein above.

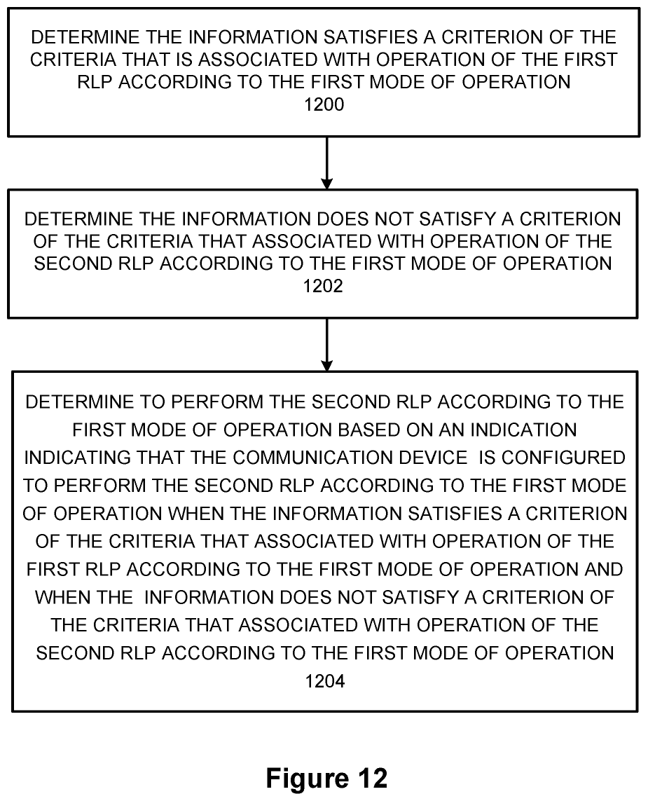

In another embodiment, FIG. 12 illustrates the method includes determining 1200 the information satisfies a criterion of the criteria that is associated with operation of the first RLP according to the first mode of operation and determining 1202 the information does not satisfy a criterion of the criteria that associated with operation of the second RLP according to the first mode of operation. However, in this embodiment, FIG. 12 illustrates the method includes determining 1204 to perform the second RLP according to the first mode of operation based on an indication indicating that the communication device is configured to perform the second RLP according to the first mode of operation when the information satisfies a criterion of the criteria that associated with operation of the first RLP according to the first mode of operation and when the information does not satisfy a criterion of the criteria that associated with operation of the second RLP according to the first mode of operation. For example, communication device 100 determines to perform the second RLP according to the first mode of operation based on the indication indicating that the communication device is configured to perform the second RLP according to the first mode of operation when the information satisfies the criterion of the criteria that associated with operation of the first RLP according to the first mode of operation and when the information does not satisfy the criterion of the criteria that associated with operation of the second RLP according to the first mode of operation. Additional examples and embodiments regarding operation of multiple RLPs according to a first mode of operation within a cell are discussed herein above. \

In some embodiments, the method includes determining to perform the second RLP further based one or more of information received from a network node, a relation between resources configured for performing the first RLP and the second RLP, and a determination on whether the first RLP is configured as the reference RLP and frequency characteristics of the cell on which the first RLP and the second RLP are performed. Additional examples and embodiments regarding determining to perform the second RLP further based on one or more information received from a network node are also discussed herein above.

Additional example embodiments are discussed below.
1. A method, performed by a communication device (100), comprising:
   obtaining (800) criteria associated with a first mode and a second mode of operation of a Radio Link Procedure (RLP) to be performed by the communication device (100);
   selecting (802) one of the first mode of operation or the second mode of operation to perform the RLP based on the criteria; and
   performing (804) the RLP according to the first or second mode of operation based on the selection.
2. The method according to embodiment 1, wherein the criteria comprises a first set of criteria that is associated with a scenario in which the communication device (100) is able to perform the RLP according to the first mode of operation; and
   wherein the criteria comprises a second set of criteria that is associated with a condition that impacts performance of the RLP when operating the RLP according to the first mode of operation.
3. The method according to any one of embodiments 1-2, wherein the scenario in which the communication device (100) is able to perform the RLP according to the first mode of operation comprises one or more of a speed of the communication device (100) and a location of the communication device (100) in a cell of a wireless network.
4. The method according to any one of embodiments 1-3, wherein the condition that impacts performance of the RLP when operating the RLP according to the first mode of operation comprises one or more of a beam failure detection, an in-sync (IS) detection, an out-of-sync (OOS) detection, a candidate beam detection, and a radio link failure trigger.
5. The method according to any of embodiments 1-4, wherein obtaining the criteria comprises obtaining the criteria from a network node (200, 300) via higher layer signaling.
6. The method according to any of embodiments 1-4, wherein the communication device (100) is pre-configured with the criteria, and wherein obtaining the criteria comprises obtaining the criteria from a storage device (105) of the communication device (100).
7. The method according to any of embodiments 1-6, wherein obtaining the criteria comprises obtaining the criteria in response to the communication device (100) one of entering a cell of a wireless network for the first time or performing a cell change in the wireless network.
8. The method according to any of embodiments 1-6, wherein obtaining the criteria comprises obtaining the criteria in response to the communication device (100) switching between Radio Resource Control (RRC) states.
9. The method according to any of embodiments 1-6, wherein obtaining the criteria comprises obtaining the criteria upon receiving an explicit request from a network node (200, 300) or based on an internal trigger within the communication device (100).
10. The method according to any one of embodiments 1-9, wherein the first mode of operation comprises a relaxed mode of operation to perform the RLP and the second mode of operation comprises a normal mode of operation to perform the RLP.
11. The method according to any one of embodiments 1-10, wherein the relaxed mode of operation comprises one or more of
   a relaxed measurement period that exceeds a normal measurement period of the normal mode of operation,
   a relaxed reference signal measurement accuracy level that exceeds a reference signal measurement accuracy level of the normal mode of operation,
   a relaxed periodicity for sending RLP indications that exceeds a normal periodicity for sending RLP indications of the normal mode operation, and/or
   a relaxed evaluation period that extends the normal evaluation period of the normal mode of operation.
12. The method according to any one of embodiments 1-11, wherein the RLP comprises one of Radio Link Monitoring (RLM) procedure and a Beam Management (BM) procedure.
13. The method according to any one of embodiments 1-12, further comprising:
   obtaining information associated with the communication device (100) operating within a cell of a wireless network.
14. The method according to any one of embodiments 1-13, wherein selecting one of the first mode of operation or the second mode of operation to perform the RLP based on the criteria comprises
   determining (900) the information satisfies the criteria, and
   selecting (902) the first mode of operation to perform the RLP based on determining the information satisfies the criteria.
15. The method according to any one of embodiments 1-13, wherein selecting one of the first mode of operation or the second mode of operation to perform the RLP based on the criteria comprises
   determining (1000) the information does not satisfy the criteria, and
   selecting (1002) the second mode of operation to perform the RLP based on determining the information does not satisfy the criteria.
16. The method according to any one of embodiments 1-13, wherein the information comprises measurement data obtained by the communication device (100) performing one or more measurements on a signal operating between the communication device (100) and the cell.
17. The method according to any one of embodiments 1-13 and 16, wherein selecting one of the first mode of operation or the second mode of operation to perform the RLP based on the criteria comprises
   selecting one of the first mode of operation or the second mode of operation to perform the RLP based on the criteria and the measurement data.
18. A method, performed by a communication device (100), comprising:
   obtaining (1100) criteria associated with a first Radio Link Procedure (RLP) and a second RLP to be performed by the communication device (100);
   determining (1102) whether to perform the first RLP and the second RLP according to a first mode of operation or a second mode of operation based on the criteria; and
   performing (1104) the first RLP and the second RLP according to the first mode of operation or the second mode of operation based on the determination.
19. The method according to any one of embodiment 18, wherein the first RLP comprises a Radio Link Monitoring (RLM) procedure and the second RLP comprises a Beam Management (BM) procedure.
20. The method according to any one of embodiments 18-19, wherein the first mode of operation comprises a relaxed mode of operation, and wherein the second mode of operation comprises a normal mode of operation.
21. The method according to any one of embodiments 18-20, wherein the relaxed mode of operation comprises one or more of
   a relaxed measurement period that exceeds a normal measurement period of the normal mode of operation,
   a relaxed reference signal measurement accuracy level that exceeds a reference signal measurement accuracy level of the normal mode of operation,
   a relaxed periodicity for sending RLP indications that exceeds a normal periodicity for sending RLP indications of the normal mode operation, and/or
   a relaxed evaluation period that extends the normal evaluation period of the normal mode of operation.
22. The method according to embodiments 18-21, wherein the criteria comprises a first set of criteria that is associated with a scenario in which the communication device (100) is able to perform the first RLP and the second RLP according to the first mode of operation; and
   wherein the criteria comprises a second set of criteria that is associated with a condition that impacts performance of the first RLP and the second RLP when operating the first RLP and the second RLP according to the first mode of operation.
23. The method according to any one of embodiments 18-22, wherein the scenario in which the communication device (100) is able to perform the first RLP and the second RLP comprises one or more of a speed of the communication device (100) and a location of the communication device (100) in a cell of a wireless network.
24. The method according to any one of embodiments 18-23, wherein the condition that impacts performance of the first RLP and the second RLP comprises one or more of a beam failure detection, an in-sync (IS) detection, an out-of-sync (OOS) detection, a candidate beam detection, and a radio link failure trigger.
25. The method according to any one of embodiments 18-24, wherein determining whether to perform the first RLP and the second RLP according to the first mode of operation or the second mode of operation based on the criteria comprises
   obtaining (1200) information associated with the communication device (100) operating within a cell of a wireless network, and
   determining (1202) whether to perform the first RLP and the second RLP according to the first mode of operation or the second mode of operation based on the criteria and the information.
26. The method according to any of one of embodiments 18-25, wherein determining whether to perform the first RLP and the second RLP according to the first mode of operation or the second mode of operation based on the criteria and the information comprises
   determining (1300) to perform the first RLP according to the first mode of operation based on the information satisfying a criterion of the criteria that associated with operation of the first RLP according to the first mode of operation, and
   determining (1302) to perform the second RLP according to the second mode of operation based on the information not satisfying a criterion of the criteria that is associated with operation of the second RLP according to the first mode of operation.
27. The method according to embodiments 18-25, wherein determining whether to perform the first RLP and the second RLP according to the first mode of operation or the second mode of operation based on the criteria and the information comprises
   determining (1400) the information satisfies a criterion of the criteria that is associated with operation of the first RLP according to the first mode of operation,
   determining (1402) the information does not satisfy a criterion of the criteria that associated with operation of the second RLP according to the first mode of operation,
   determining (1404) to perform the second RLP according to the first mode of operation based on an indication indicating that the communication device is configured to perform the second RLP according to the first mode of operation when the information satisfies a criterion of the criteria that associated with operation of the first RLP according to the first mode of operation and when the information does not satisfy a criterion of the criteria that associated with operation of the second RLP according to the first mode of operation.
28. The method according to embodiment 27, wherein determining to perform the second RLP according to the first mode of operation further comprises determining to perform the second RLP further based one or more of information received from a network node, a relation between resources configured for performing the first RLP and the second RLP, and a determination on whether the first RLP is configured as the reference RLP and frequency characteristics of the cell on which the first RLP and the second RLP are performed.
29. A communication device (100) comprising:
   processing circuitry (103); and
   memory (105) coupled with the processing circuitry, wherein the memory includes instructions that when executed by the processing circuitry causes the communication device to perform operations according to any of Embodiments 1-17.
30. A communication device (100) adapted to perform according to any of Embodiments 1-17.
31. A computer program comprising program code to be executed by processing circuitry (103) of a communication device (100), whereby execution of the program code causes the communication device (100) to perform operations according to any of embodiments 1-17.
32. A computer program product comprising a non-transitory storage medium including program code to be executed by processing circuitry (103) of a communication device (100), whereby execution of the program code causes the communication device (100) to perform operations according to any of embodiments 1-17.
33. A communication device (100) comprising:
   processing circuitry (103); and
   memory (105) coupled with the processing circuitry, wherein the memory includes instructions that when executed by the processing circuitry causes the communication device to perform operations according to any of Embodiments 18-28.
34. A communication device (100) adapted to perform according to any of Embodiments 18-28.
35. A computer program comprising program code to be executed by processing circuitry (103) of a communication device (100), whereby execution of the program code causes the communication device (100) to perform operations according to any of embodiments 18-28.
36. A computer program product comprising a non-transitory storage medium including program code to be executed by processing circuitry (103) of a communication device (100), whereby execution of the program code causes the communication device (100) to perform operations according to any of embodiments 18-28.

Explanations are provided below for various abbreviations/acronyms used in the present disclosure.

### Abbreviation Explanation

BFD Beam failure detection
BM Beam management
BS Base station
CBD Candidate beam detection
CCA Clear channel assessment
CE Control element
CGI Cell global ID
CRS Cell-specific reference signals
CSI Channel state information
CSI-RS Channel state information reference signals
DC Dual connectivity
DCI Downlink control information
DL Downlink
eNB E-UTRAN NodeB
FDD Frequency division duplex
FR1 Frequency range 1
FR2 Frequency range 2
GSCN Global synchronization channel number
gNB Next generation Node B
HARQ Hybrid automatic repeat request
IS In-sync
LTE Long term evolution
MAC Medium access control
MC Multi-carrier
MuC Multi-connectivity
NR New radio
Out-of-sync
PBCH Physical broadcast channel
PCI Physical cell ID
PDCCH Physical downlink control channel
PDSCH Physical downlink shared channel
PSS Primary synchronization signal
PUCCH Physical uplink control channel
PUSCH Physical uplink shared channel
RACH Rando access channel
RAT Radio access technology
RLM Radio link monitoring
RLP Radio link procedure
RRC Radio resource control
RSRP Received signal reference power
RSRQ Received signal reference quality
SCH Shared channel
SNR Signal to noise ratio
SRS Sounding reference signal
SS-RSRP Secondary synchronization RSRP
SS-RSRQ Secondary synchronization RSRQ
SSS Secondary synchronization signal
TCI Transmission configuration indicator
ProSe Proximity Services
V2V Vehicle-to-Vehicle
V2X Vehicle-to-everything

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 13 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360b, and WDs 1310, 1310b, and 1310c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2nd generation (2G), 3rd generation (3G), fourth generation (4G), or fifth generation (5G) standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1360 are depicted as single boxes located within a larger box, or nested within multiple boxes, in practice, a network node may comprise multiple different physical components that make up a single illustrated component (e.g., device readable medium 1380 may comprise multiple separate hard drives as well as multiple RAM modules).

Similarly, network node 1360 may be composed of multiple physically separate components (e.g., a NodeB component and a RNC component, or a BTS component and a BSC component, etc.), which may each have their own respective components. In certain scenarios in which network node 1360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1360 may be configured to support multiple radio access technologies (RATs). In such embodiments, some components may be duplicated (e.g., separate device readable medium 1380 for the different RATs) and some components may be reused (e.g., the same antenna 1362 may be shared by the RATs). Network node 1360 may also include multiple sets of the various illustrated components for different wireless technologies integrated into network node 1360, such as, for example, GSM, wide code division multiplexing access (WCDMA), LTE, NR, WiFi, or Bluetooth wireless technologies. These wireless technologies may be integrated into the same or different chip or set of chips and other components within network node 1360.

Processing circuitry 1370 is configured to perform any determining, calculating, or similar operations (e.g., certain obtaining operations) described herein as being provided by a network node. These operations performed by processing circuitry 1370 may include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 may execute instructions stored in device readable medium 1380 or in memory within processing circuitry 1370. Such functionality may include providing any of the various wireless features, functions, or benefits discussed herein. In some embodiments, processing circuitry 1370 may include a system on a chip (SOC).

In some embodiments, processing circuitry 1370 may include one or more of radio frequency (RF) transceiver circuitry 1372 and baseband processing circuitry 1374. In some embodiments, radio frequency (RF) transceiver circuitry 1372 and baseband processing circuitry 1374 may be on separate chips (or sets of chips), boards, or units, such as radio units and digital units. In alternative embodiments, part or all of RF transceiver circuitry 1372 and baseband processing circuitry 1374 may be on the same chip or set of chips, boards, or units.

In certain embodiments, some or all of the functionality described herein as being provided by a network node, base station, eNB or other such network device may be performed by processing circuitry 1370 executing instructions stored on device readable medium 1380 or memory within processing circuitry 1370. In alternative embodiments, some or all of the functionality may be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1370. Device readable medium 1380 may store any suitable instructions, data or information, including a computer program, software, an application including one or more of logic, rules, code, tables, etc. and/or other instructions capable of being executed by processing circuitry 1370 and, utilized by network node 1360. Device readable medium 1380 may be used to store any calculations made by processing circuitry 1370 and/or any data received via interface 1390. In some embodiments, processing circuitry 1370 and device readable medium 1380 may be considered to be integrated.

Interface 1390 is used in the wired or wireless communication of signalling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that may be coupled to, or in certain embodiments a part of, antenna 1362. Radio front end circuitry 1392 comprises filters 1398 and amplifiers 1396. Radio front end circuitry 1392 may be connected to antenna 1362 and processing circuitry 1370. Radio front end circuitry may be configured to condition signals communicated between antenna 1362 and processing circuitry 1370. Radio front end circuitry 1392 may receive digital data that is to be sent out to other network nodes or WDs via a wireless connection. Radio front end circuitry 1392 may convert the digital data into a radio signal having the appropriate channel and bandwidth parameters using a combination of filters 1398 and/or amplifiers 1396. The radio signal may then be transmitted via antenna 1362. Similarly, when receiving data, antenna 1362 may collect radio signals which are then converted into digital data by radio front end circuitry 1392. The digital data may be passed to processing circuitry 1370. In other embodiments, the interface may comprise different components and/or different combinations of components.

In certain alternative embodiments, network node 1360 may not include separate radio front end circuitry 1392, instead, processing circuitry 1370 may comprise radio front end circuitry and may be connected to antenna 1362 without separate radio front end circuitry 1392. Similarly, in some embodiments, all or some of RF transceiver circuitry 1372 may be considered a part of interface 1390. In still other embodiments, interface 1390 may include one or more ports or terminals 1394, radio front end circuitry 1392, and RF transceiver circuitry 1372, as part of a radio unit (not shown), and interface 1390 may communicate with baseband processing circuitry 1374, which is part of a digital unit (not shown).

Antenna 1362 may include one or more antennas, or antenna arrays, configured to send and/or receive wireless signals. Antenna 1362 may be coupled to radio front end circuitry 1392 and may be any type of antenna capable of transmitting and receiving data and/or signals wirelessly. In some embodiments, antenna 1362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1362 may be separate from network node 1360 and may be connectable to network node 1360 through an interface or port.

Antenna 1362, interface 1390, and/or processing circuitry 1370 may be configured to perform any receiving operations and/or certain obtaining operations described herein as being performed by a network node. Any information, data and/or signals may be received from a wireless device, another network node and/or any other network equipment. Similarly, antenna 1362, interface 1390, and/or processing circuitry 1370 may be configured to perform any transmitting operations described herein as being performed by a network node. Any information, data and/or signals may be transmitted to a wireless device, another network node and/or any other network equipment.

Power circuitry 1387 may comprise, or be coupled to, power management circuitry and is configured to supply the components of network node 1360 with power for performing the functionality described herein. Power circuitry 1387 may receive power from power source 1386. Power source 1386 and/or power circuitry 1387 may be configured to provide power to the various components of network node 1360 in a form suitable for the respective components (e.g., at a voltage and current level needed for each respective component). Power source 1386 may either be included in, or external to, power circuitry 1387 and/or network node 1360. For example, network node 1360 may be connectable to an external power source (e.g., an electricity outlet) via an input circuitry or interface such as an electrical cable, whereby the external power source supplies power to power circuitry 1387. As a further example, power source 1386 may comprise a source of power in the form of a battery or battery pack which is connected to, or integrated in, power circuitry 1387. The battery may provide backup power should the external power source fail. Other types of power sources, such as photovoltaic devices, may also be used.

Alternative embodiments of network node 1360 may include additional components beyond those shown in FIG. 13 that may be responsible for providing certain aspects of the network node's functionality, including any of the functionality described herein and/or any functionality necessary to support the subject matter described herein. For example, network node 1360 may include user interface equipment to allow input of information into network node 1360 and to allow output of information from network node 1360. This may allow a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 may include multiple sets of one or more of the illustrated components for different wireless technologies supported by WD 1310, such as, for example, GSM, WCDMA, LTE, NR, WiFi, WiMAX, or Bluetooth wireless technologies, just to mention a few. These wireless technologies may be integrated into the same or different chips or set of chips as other components within WD 1310.

Antenna 1311 may include one or more antennas or antenna arrays, configured to send and/or receive wireless signals, and is connected to interface 1314. In certain alternative embodiments, antenna 1311 may be separate from WD 1310 and be connectable to WD 1310 through an interface or port. Antenna 1311, interface 1314, and/or processing circuitry 1320 may be configured to perform any receiving or transmitting operations described herein as being performed by a WD. Any information, data and/or signals may be received from a network node and/or another WD. In some embodiments, radio front end circuitry and/or antenna 1311 may be considered an interface.

As illustrated, interface 1314 comprises radio front end circuitry 1312 and antenna 1311. Radio front end circuitry 1312 comprise one or more filters 1318 and amplifiers 1316. Radio front end circuitry 1312 is connected to antenna 1311 and processing circuitry 1320, and is configured to condition signals communicated between antenna 1311 and processing circuitry 1320. Radio front end circuitry 1312 may be coupled to or a part of antenna 1311. In some embodiments, WD 1310 may not include separate radio front end circuitry 1312; rather, processing circuitry 1320 may comprise radio front end circuitry and may be connected to antenna 1311. Similarly, in some embodiments, some or all of RF transceiver circuitry 1322 may be considered a part of interface 1314. Radio front end circuitry 1312 may receive digital data that is to be sent out to other network nodes or WDs via a wireless connection. Radio front end circuitry 1312 may convert the digital data into a radio signal having the appropriate channel and bandwidth parameters using a combination of filters 1318 and/or amplifiers 1316. The radio signal may then be transmitted via antenna 1311. Similarly, when receiving data, antenna 1311 may collect radio signals which are then converted into digital data by radio front end circuitry 1312. The digital data may be passed to processing circuitry 1320. In other embodiments, the interface may comprise different components and/or different combinations of components.

Processing circuitry 1320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality may include providing any of the various wireless features or benefits discussed herein. For example, processing circuitry 1320 may execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry may comprise different components and/or different combinations of components. In certain embodiments processing circuitry 1320 of WD 1310 may comprise a SOC. In some embodiments, RF transceiver circuitry 1322, baseband processing circuitry 1324, and application processing circuitry 1326 may be on separate chips or sets of chips. In alternative embodiments, part or all of baseband processing circuitry 1324 and application processing circuitry 1326 may be combined into one chip or set of chips, and RF transceiver circuitry 1322 may be on a separate chip or set of chips. In still alternative embodiments, part or all of RF transceiver circuitry 1322 and baseband processing circuitry 1324 may be on the same chip or set of chips, and application processing circuitry 1326 may be on a separate chip or set of chips. In yet other alternative embodiments, part or all of RF transceiver circuitry 1322, baseband processing circuitry 1324, and application processing circuitry 1326 may be combined in the same chip or set of chips. In some embodiments, RF transceiver circuitry 1322 may be a part of interface 1314. RF transceiver circuitry 1322 may condition RF signals for processing circuitry 1320.

In certain embodiments, some or all of the functionality described herein as being performed by a WD may be provided by processing circuitry 1320 executing instructions stored on device readable medium 1330, which in certain embodiments may be a computer-readable storage medium. In alternative embodiments, some or all of the functionality may be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 may be configured to perform any determining, calculating, or similar operations (e.g., certain obtaining operations) described herein as being performed by a WD. These operations, as performed by processing circuitry 1320, may include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 may be operable to store a computer program, software, an application including one or more of logic, rules, code, tables, etc. and/or other instructions capable of being executed by processing circuitry 1320. Device readable medium 1330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1320. In some embodiments, processing circuitry 1320 and device readable medium 1330 may be considered to be integrated.

User interface equipment 1332 may provide components that allow for a human user to interact with WD 1310. Such interaction may be of many forms, such as visual, audial, tactile, etc. User interface equipment 1332 may be operable to produce output to the user and to allow the user to provide input to WD 1310. The type of interaction may vary depending on the type of user interface equipment 1332 installed in WD 1310. For example, if WD 1310 is a smart phone, the interaction may be via a touch screen; if WD 1310 is a smart meter, the interaction may be through a screen that provides usage (e.g., the number of gallons used) or a speaker that provides an audible alert (e.g., if smoke is detected). User interface equipment 1332 may include input interfaces, devices and circuits, and output interfaces, devices and circuits. User interface equipment 1332 is configured to allow input of information into WD 1310, and is connected to processing circuitry 1320 to allow processing circuitry 1320 to process the input information. User interface equipment 1332 may include, for example, a microphone, a proximity or other sensor, keys/buttons, a touch display, one or more cameras, a USB port, or other input circuitry. User interface equipment 1332 is also configured to allow output of information from WD 1310, and to allow processing circuitry 1320 to output information from WD 1310. User interface equipment 1332 may include, for example, a speaker, a display, vibrating circuitry, a USB port, a headphone interface, or other output circuitry. Using one or more input and output interfaces, devices, and circuits, of user interface equipment 1332, WD 1310 may communicate with end users and/or the wireless network, and allow them to benefit from the functionality described herein.

Auxiliary equipment 1334 is operable to provide more specific functionality which may not be generally performed by WDs. This may comprise specialized sensors for doing measurements for various purposes, interfaces for additional types of communication such as wired communications etc. The inclusion and type of components of auxiliary equipment 1334 may vary depending on the embodiment and/or scenario.

Power source 1336 may, in some embodiments, be in the form of a battery or battery pack. Other types of power sources, such as an external power source (e.g., an electricity outlet), photovoltaic devices or power cells, may also be used. WD 1310 may further comprise power circuitry 1337 for delivering power from power source 1336 to the various parts of WD 1310 which need power from power source 1336 to carry out any functionality described or indicated herein. Power circuitry 1337 may in certain embodiments comprise power management circuitry. Power circuitry 1337 may additionally or alternatively be operable to receive power from an external power source; in which case WD 1310 may be connectable to the external power source (such as an electricity outlet) via input circuitry or an interface such as an electrical power cable. Power circuitry 1337 may also in certain embodiments be operable to deliver power from an external power source to power source 1336. This may be, for example, for the charging of power source 1336. Power circuitry 1337 may perform any formatting, converting, or other modification to the power from power source 1336 to make the power suitable for the respective components of WD 1310 to which power is supplied.

FIG. 14 illustrates a user Equipment in accordance with some embodiments.

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1400 may be any UE identified by the 3rd Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1419, and storage medium 1421 or the like, communication subsystem 1431, power source 1413, and/or any other component, or any combination thereof. Storage medium 1421 includes operating system 1423, application program 1425, and data 1427. In other embodiments, storage medium 1421 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1401 may be configured to process computer instructions and data. Processing circuitry 1401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 may include two central processing units (CPUs). Data may be information in a form suitable for use by a computer.

In the depicted embodiment, input/output interface 1405 may be configured to provide a communication interface to an input device, output device, or input and output device. UE 1400 may be configured to use an output device via input/output interface 1405. An output device may use the same type of interface port as an input device. For example, a USB port may be used to provide input to and output from UE 1400. The output device may be a speaker, a sound card, a video card, a display, a monitor, a printer, an actuator, an emitter, a smartcard, another output device, or any combination thereof. UE 1400 may be configured to use an input device via input/output interface 1405 to allow a user to capture information into UE 1400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1409 may be configured to provide a communication interface to RF components such as a transmitter, a receiver, and an antenna. Network connection interface 1411 may be configured to provide a communication interface to network 1443a. Network 1443a may encompass wired and/or wireless networks such as a local-area network (LAN), a wide-area network (WAN), a computer network, a wireless network, a telecommunications network, another like network or any combination thereof. For example, network 1443a may comprise a Wi-Fi network. Network connection interface 1411 may be configured to include a receiver and a transmitter interface used to communicate with one or more other devices over a communication network according to one or more communication protocols, such as Ethernet, TCP/IP, SONET, ATM, or the like. Network connection interface 1411 may implement receiver and transmitter functionality appropriate to the communication network links (e.g., optical, electrical, and the like). The transmitter and receiver functions may share circuit components, software or firmware, or alternatively may be implemented separately.

RAM 1417 may be configured to interface via bus 1402 to processing circuitry 1401 to provide storage or caching of data or computer instructions during the execution of software programs such as the operating system, application programs, and device drivers. ROM 1419 may be configured to provide computer instructions or data to processing circuitry 1401. For example, ROM 1419 may be configured to store invariant low-level system code or data for basic system functions such as basic input and output (I/O), startup, or reception of keystrokes from a keyboard that are stored in a non-volatile memory. Storage medium 1421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 may be configured to include operating system 1423, application program 1425 such as a web browser application, a widget or gadget engine or another application, and data file 1427. Storage medium 1421 may store, for use by UE 1400, any of a variety of various operating systems or combinations of operating systems.

Storage medium 1421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 may allow UE 1400 to access computer-executable instructions, application programs or the like, stored on transitory or non-transitory memory media, to off-load data, or to upload data. An article of manufacture, such as one utilizing a communication system may be tangibly embodied in storage medium 1421, which may comprise a device readable medium.

In FIG. 14, processing circuitry 1401 may be configured to communicate with network 1443b using communication subsystem 1431. Network 1443a and network 1443b may be the same network or networks or different network or networks. Communication subsystem 1431 may be configured to include one or more transceivers used to communicate with network 1443b. For example, communication subsystem 1431 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1433 and/or receiver 1435 to implement transmitter or receiver functionality, respectively, appropriate to the RAN links (e.g., frequency allocations and the like). Further, transmitter 1433 and receiver 1435 of each transceiver may share circuit components, software or firmware, or alternatively may be implemented separately.

In the illustrated embodiment, the communication functions of communication subsystem 1431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 may include cellular communication, Wi-Fi communication, Bluetooth communication, and GPS communication. Network 1443b may encompass wired and/or wireless networks such as a local-area network (LAN), a wide-area network (WAN), a computer network, a wireless network, a telecommunications network, another like network or any combination thereof. For example, network 1443b may be a cellular network, a Wi-Fi network, and/or a near-field network. Power source 1413 may be configured to provide alternating current (AC) or direct current (DC) power to components of UE 1400.

The features, benefits and/or functions described herein may be implemented in one of the components of UE 1400 or partitioned across multiple components of UE 1400. Further, the features, benefits, and/or functions described herein may be implemented in any combination of hardware, software or firmware. In one example, communication subsystem 1431 may be configured to include any of the components described herein. Further, processing circuitry 1401 may be configured to communicate with any of such components over bus 1402. In another example, any of such components may be represented by program instructions stored in memory that when executed by processing circuitry 1401 perform the corresponding functions described herein. In another example, the functionality of any of such components may be partitioned between processing circuitry 1401 and communication subsystem 1431. In another example, the non-computationally intensive functions of any of such components may be implemented in software or firmware and the computationally intensive functions may be implemented in hardware.

FIG. 15 illustrates a virtualization environment in accordance with some embodiments.

FIG. 15 is a schematic block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node may be entirely virtualized.

The functions may be implemented by one or more applications 1520 (which may alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which may be commercial off-the-shelf (COTS) processors, dedicated Application Specific Integrated Circuits (ASICs), or any other type of processing circuitry including digital or analog hardware components or special purpose processors. Each hardware device may comprise memory 1590-1 which may be non-persistent memory for temporarily storing instructions 1595 or software executed by processing circuitry 1560. Each hardware device may comprise one or more network interface controllers (NICs) 1570, also known as network interface cards, which include physical network interface 1580. Each hardware device may also include non-transitory, persistent, machine-readable storage media 1590-2 having stored therein software 1595 and/or instructions executable by processing circuitry 1560. Software 1595 may include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540 comprise virtual processing, virtual memory, virtual networking or interface and virtual storage, and may be run by a corresponding virtualization layer 1550 or hypervisor. Different embodiments of the instance of virtual appliance 1520 may be implemented on one or more of virtual machines 1540, and the implementations may be made in different ways.

During operation, processing circuitry 1560 executes software 1595 to instantiate the hypervisor or virtualization layer 1550, which may sometimes be referred to as a virtual machine monitor (VMM). Virtualization layer 1550 may present a virtual operating platform that appears like networking hardware to virtual machine 1540.

As shown in FIG. 15, hardware 1530 may be a standalone network node with generic or specific components. Hardware 1530 may comprise antenna 15225 and may implement some functions via virtualization. Alternatively, hardware 1530 may be part of a larger cluster of hardware (e.g. such as in a data center or customer premise equipment (CPE)) where many hardware nodes work together and are managed via management and orchestration (MANO) 15100, which, among others, oversees lifecycle management of applications 1520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1540 may be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 may be coupled to one or more antennas 15225. Radio units 15200 may communicate directly with hardware nodes 1530 via one or more appropriate network interfaces and may be used in combination with the virtual components to provide a virtual node with radio capabilities, such as a radio access node or a base station.

In some embodiments, some signalling can be effected with the use of control system 15230 which may alternatively be used for communication between the hardware nodes 1530 and radio units 15200.

FIG. 16 illustrates a telecommunication network connected via an intermediate network to a host computer in accordance with some embodiments.

With reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which may be embodied in the hardware and/or software of a standalone server, a cloud-implemented server, a distributed server or as processing resources in a server farm. Host computer 1630 may be under the ownership or control of a service provider, or may be operated by the service provider or on behalf of the service provider. Connections 1621 and 1622 between telecommunication network 1610 and host computer 1630 may extend directly from core network 1614 to host computer 1630 or may go via an optional intermediate network 1620. Intermediate network 1620 may be one of, or a combination of more than one of, a public, private or hosted network; intermediate network 1620, if any, may be a backbone network or the Internet; in particular, intermediate network 1620 may comprise two or more sub-networks (not shown).

The communication system of FIG. 16 as a whole enables connectivity between the connected UEs 1691, 1692 and host computer 1630. The connectivity may be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 may be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

FIG. 17 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 17. In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which may have storage and/or processing capabilities. In particular, processing circuitry 1718 may comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 may be operable to provide a service to a remote user, such as UE 1730 connecting via OTT connection 1750 terminating at UE 1730 and host computer 1710. In providing the service to the remote user, host application 1712 may provide user data which is transmitted using OTT connection 1750.

Communication system 1700 further includes base station 1720 provided in a telecommunication system and comprising hardware 1725 enabling it to communicate with host computer 1710 and with UE 1730. Hardware 1725 may include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 may be configured to facilitate connection 1760 to host computer 1710. Connection 1760 may be direct or it may pass through a core network (not shown in FIG. 17) of the telecommunication system and/or through one or more intermediate networks outside the telecommunication system. In the embodiment shown, hardware 1725 of base station 1720 further includes processing circuitry 1728, which may comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 further includes UE 1730 already referred to. Its hardware 1735 may include radio interface 1737 configured to set up and maintain wireless connection 1770 with a base station serving a coverage area in which UE 1730 is currently located. Hardware 1735 of UE 1730 further includes processing circuitry 1738, which may comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 may be operable to provide a service to a human or non-human user via UE 1730, with the support of host computer 1710. In host computer 1710, an executing host application 1712 may communicate with the executing client application 1732 via OTT connection 1750 terminating at UE 1730 and host computer 1710. In providing the service to the user, client application 1732 may receive request data from host application 1712 and provide user data in response to the request data. OTT connection 1750 may transfer both the request data and the user data. Client application 1732 may interact with the user to generate the user data that it provides.

It is noted that host computer 1710, base station 1720 and UE 1730 illustrated in FIG. 17 may be similar or identical to host computer 1630, one of base stations 1612a, 1612b, 1612c and one of UEs 1691, 1692 of FIG. 16, respectively. This is to say, the inner workings of these entities may be as shown in FIG. 17 and independently, the surrounding network topology may be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure may determine the routing, which it may be configured to hide from UE 1730 or from the service provider operating host computer 1710, or both. While OTT connection 1750 is active, the network infrastructure may further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments may improve the performance of OTT services provided to UE 1730 using OTT connection 1750, in which wireless connection 1770 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 1750 between host computer 1710 and UE 1730, in response to variations in the measurement results. The measurement procedure and/or the network functionality for reconfiguring OTT connection 1750 may be implemented in software 1711 and hardware 1715 of host computer 1710 or in software 1731 and hardware 1735 of UE 1730, or both. In embodiments, sensors (not shown) may be deployed in or in association with communication devices through which OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of OTT connection 1750 may include message format, retransmission settings, preferred routing etc.; the reconfiguring need not affect base station 1720, and it may be unknown or imperceptible to base station 1720. Such procedures and functionalities may be known and practiced in the art. In certain embodiments, measurements may involve proprietary UE signaling facilitating host computer 1710's measurements of throughput, propagation times, latency and the like. The measurements may be implemented in that software 1711 and 1731 causes messages to be transmitted, in particular empty or ‘dummy’ messages, using OTT connection 1750 while it monitors propagation times, errors etc.

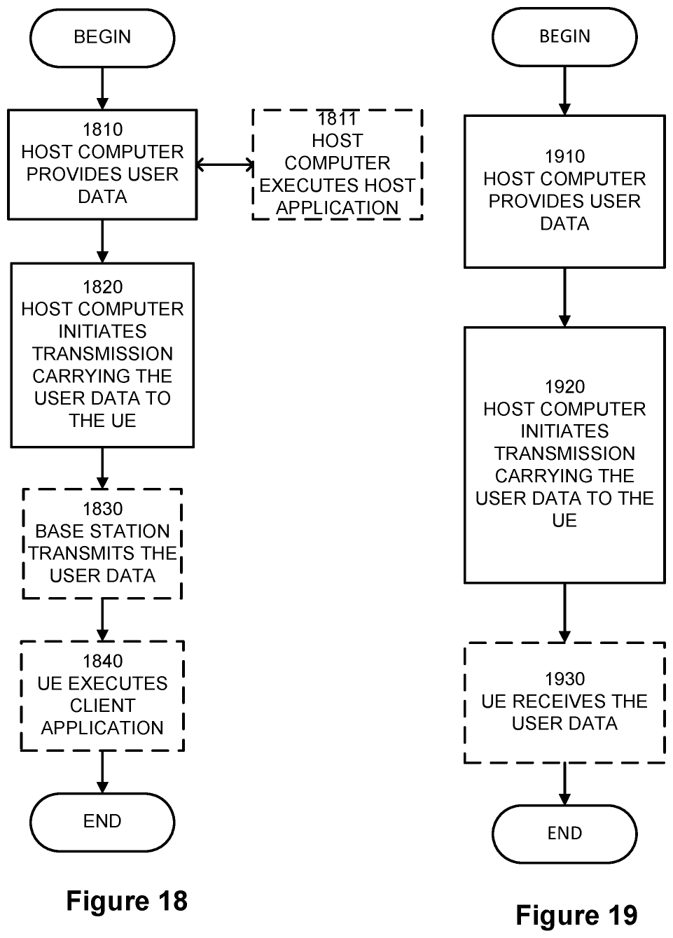

FIG. 18 illustrates methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1810, the host computer provides user data. In substep 1811 (which may be optional) of step 1810, the host computer provides the user data by executing a host application. In step 1820, the host computer initiates a transmission carrying the user data to the UE. In step 1830 (which may be optional), the base station transmits to the UE the user data which was carried in the transmission that the host computer initiated, in accordance with the teachings of the embodiments described throughout this disclosure. In step 1840 (which may also be optional), the UE executes a client application associated with the host application executed by the host computer.

FIG. 19 illustrates methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission may pass via the base station, in accordance with the teachings of the embodiments described throughout this disclosure. In step 1930 (which may be optional), the UE receives the user data carried in the transmission.

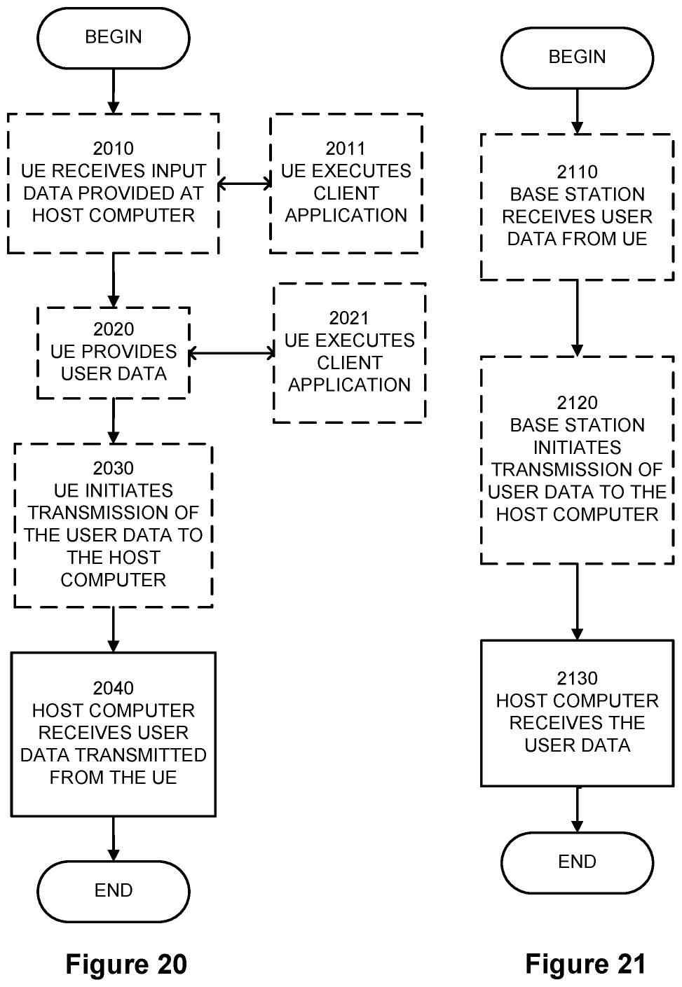

FIG. 20 illustrates methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

FIG. 21 illustrates methods implemented in a communication system including a host computer, a base station and a user equipment in accordance with some embodiments.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method, performed by a communication device, comprising:
obtaining criteria associated with a first mode of operation and a second mode of operation of a Radio Link Procedure (RLP) to be performed by the communication device;
selecting one of the first mode of operation and the second mode of operation to perform the RLP based on the criteria; and
performing the RLP according to the first mode of operation or the second mode of operation based on the selection.

2. The method according to claim 1, wherein the criteria comprises a first set of criteria that is associated with a scenario in which the communication device is able to perform the RLP according to the first mode of operation; and
wherein the criteria comprises a second set of criteria that is associated with a condition that impacts performance of the RLP when operating the RLP according to the first mode of operation.

3. (canceled)

4. The method according to claim 1, wherein the condition that impacts performance of the RLP when operating the RLP according to the first mode of operation comprises one or more of a beam failure detection, an in-sync (IS) detection, an out-of-sync (OOS) detection, a candidate beam detection, and a radio link failure trigger.

5. The method according to claim 1, wherein obtaining the criteria comprises obtaining the criteria from a network node via higher layer signaling.

6. (canceled)

7. The method according to claim 1, wherein obtaining the criteria comprises obtaining the criteria in response to the communication device one of entering a cell of a wireless network for a first time and performing a cell change in the wireless network.

8. The method according to claim 1, wherein obtaining the criteria comprises obtaining the criteria in response to the communication device switching between Radio Resource Control (RRC) states.

9. (canceled)

10. The method according to claim 1, wherein the first mode of operation comprises a relaxed mode of operation to perform the RLP and the second mode of operation comprises a normal mode of operation to perform the RLP.

11. The method according to claim 1, wherein the relaxed mode of operation comprises one or more of:
a relaxed measurement period that exceeds a normal measurement period of the normal mode of operation,
a relaxed reference signal measurement accuracy level that exceeds a reference signal measurement accuracy level of the normal mode of operation,
a relaxed periodicity for sending RLP indications that exceeds a normal periodicity for sending RLP indications of the normal mode operation, and/or
a relaxed evaluation period that extends the normal evaluation period of the normal mode of operation.

12. The method according to claim 1, wherein the RLP comprises one of Radio Link Monitoring (RLM) procedure and a Link Recovery (LR) procedure.

13. (canceled)

14. The method of claim 1, wherein the first mode of operation comprises a relaxed mode of operation to perform the RLP and the second mode of operation comprises a normal mode of operation to perform the RLP and obtaining the criteria associated with the first mode of operation and the second mode of operation comprises a first set of criteria associated with the first mode of operation and a second set of criteria associated with the second mode of operation and selecting one of the first mode of operation or the second mode of operation to perform the RLP comprises:
responsive to at least one first criterion in the first set of criteria being met and at least one second criterion in the second set of criteria being met, performing RLP in the first mode of operation; and
responsive to at least one first criterion in the first set of criteria not being met and/or at least one second criterion in the second set of criteria not being met, performing RLP in the second mode of operation.

15. The method of claim 14, further comprising:
while operating in the first mode of operation, reverting to the second mode of operation responsive to detecting a certain number of out-of-sync indications or upon triggering a T310 timer, or upon observing link quality degradation above a threshold, or a mobility state change.

16. The method of claim 14, wherein the first set of criteria is based on one or more of a speed of the communication device, a location of the communication device in a cell of a wireless network, a signal level variation compared to a signal level variation threshold, a reference signal received power, RSRP, variation compared to a RSRP variation threshold level or a signal to interference and noise ratio, SINR, variation compared to a SINR variation threshold level.

17.-22. (canceled)

23. A method, performed by a communication device, comprising:
obtaining criteria associated with a first Radio Link Procedure (RLP) and a second RLP to be performed by the communication device;
determining whether to perform the first RLP and the second RLP according to a first mode of operation or a second mode of operation based on the criteria; and
performing the first RLP and the second RLP according to the first mode of operation or the second mode of operation based on the determination.

24. The method according to claim 23, wherein the first RLP comprises a Radio Link Monitoring (RLM) procedure and the second RLP comprises a Link Recovery (LR) procedure.

25. The method according to claim 24, wherein the LR procedure comprising one or more of beam failure detection, candidate beam detection and L1-RSRP reporting.

26. The method according to claim 23, wherein the first mode of operation comprises a relaxed mode of operation, and wherein the second mode of operation comprises a normal mode of operation.

27. The method according to claim 23, wherein the relaxed mode of operation comprises one or more of
a relaxed measurement period that exceeds a normal measurement period of the normal mode of operation,
a relaxed reference signal measurement accuracy level that exceeds a reference signal measurement accuracy level of the normal mode of operation,
a relaxed periodicity for sending RLP indications that exceeds a normal periodicity for sending RLP indications of the normal mode operation, and/or
a relaxed evaluation period that extends the normal evaluation period of the normal mode of operation.

28. The method according to claim 23, wherein the criteria comprises a first set of criteria that is associated with a scenario in which the communication device is able to perform the first RLP and the second RLP according to the first mode of operation; and
wherein the criteria comprises a second set of criteria that is associated with a condition that impacts performance of the first RLP and the second RLP when operating the first RLP and the second RLP according to the first mode of operation.

29. (canceled)

30. The method according to claim 23, wherein the condition that impacts performance of the first RLP and the second RLP comprises one or more of a beam failure detection, an in-sync (IS) detection, an out-of-sync (OOS) detection, a candidate beam detection, and a radio link failure trigger.

31. The method of claim 23, wherein the first mode of operation comprises a relaxed mode of operation to perform the RLP and the second mode of operation comprises a normal mode of operation to perform the RLP and obtaining the criteria associated with the first RLP and the second RLP comprises a first set of criteria associated with the first mode of operation and a second set of criteria associated with the second mode of operation and selecting one of the first mode of operation or the second mode of operation to perform the RLP comprises:
responsive to at least one first criterion in the first set of criteria being met and at least one second criterion in the second set of criteria being met, performing the first RLP and the second RLP in the first mode of operation; and
responsive to at least one first criterion in the first set of criteria not being met and/or at least one second criterion in the second set of criteria not being met, performing the first RLP and the second RLP in the second mode of operation.

32. The method of claim 31, further comprising:
while operating in the first mode of operation, reverting to the second mode of operation responsive to detecting a certain number of out-of-sync indications or upon triggering a T310 timer, or upon observing link quality degradation above a threshold, or a mobility state change.

33. The method of claim 31, wherein the first set of criteria is based on one or more of a speed of the communication device, a location of the communication device in a cell of a wireless network, a signal level variation compared to a signal level variation threshold, a reference signal received power, RSRP, variation compared to a RSRP variation threshold level or a signal to interference and nose ratio, SINR, variation compared to a SINR variation threshold level.

34. (canceled)

35. The method according to claim 23, wherein determining whether to perform the first RLP and the second RLP according to the first mode of operation or the second mode of operation based on the criteria comprises
obtaining information associated with the communication device operating within a cell of a wireless network, and
determining whether to perform the first RLP and the second RLP according to the first mode of operation or the second mode of operation based on the criteria and the information.

36.-38. (canceled)

39. A communication device comprising:
processing circuitry; and
memory coupled with the processing circuitry, wherein the memory includes instructions that when executed by the processing circuitry causes the communication device to perform operations according to claim 1.

40. A communication device adapted to perform according to claims 1.

41.-42. (canceled)

43. A communication device comprising:
processing circuitry; and
memory coupled with the processing circuitry, wherein the memory includes instructions that when executed by the processing circuitry causes the communication device to perform operations according to claim 23.

44. A communication device adapted to perform according to claims 23.

45.-46. (canceled)
